(19) United States
(12) Patent Application Publication
(10) Pub. No.: US 2015/0249325 A1
(43) Pub. Date: Sep. 3, 2015

(54) METHOD FOR STRINGING REPLACEMENT OPTICAL GROUND WIRE OR STATIC WIRE NEAR ENERGIZED POWER LINES

(71) Applicant: QUANTA ASSOCIATES, LP, HOUSTON, TX (US)

(72) Inventors: Daniel Neil O'Connell, Oliver (CA); David Karl Wabnegger, Langley (CA)

(21) Appl. No.: 14/633,749

(22) Filed: Feb. 27, 2015

Related U.S. Application Data
(60) Provisional application No. 61/946,011, filed on Feb. 28, 2014.

(51) Int. Cl. H02G 1/04

(52) U.S. Cl. CPC H02G 1/04

(57) ABSTRACT

A method of stringing replacement static lines on an energized overhead power line system, wherein both the old and new static wire is grounded at substantially each support structure within a pull zone during static wire maintenance and replacement operations, the method including at least the steps of (a) removing a length of an old static wire from the pull zone portion of the system; (b) stringing in a length of replacement static wire into the portion of the system; (c) maintaining an electrical connection between earth and the old static wire during step (a); and (d) maintaining an electrical connection between the earth and the replacement static wire during step (b), while at substantially all times maintaining a grounding connection from the old static wires and the new, replacement static wires to substantially each support structure, and therealong to ground, along the pull zone portion of the system.

### TECHNICAL FIELD

This disclosure generally relates to a method for stringing replacement optical ground wire or static wire above energized power lines.

### BACKGROUND

Overhead power line systems use one or more phases of conductors to transmit electricity within a transmission grid. The overhead power lines may be used for bulk transmission from a power plant to centers of high demand and for distribution within the centers of high demand. The conductors are often supported above the ground by support structures, including towers, which are usually of metal lattice construction, and poles, which may be of wood, cement or steel (collectively referred to herein as support structures). Over time the energized transmission lines, referred to herein as energized conductors, may be exposed to harsh weather conditions, which may include lightning strikes. To shield the energized conductors from lightning strikes, one or more static wires, which may be conventional static wires or otherwise may be referred to as overhead ground wire, shield wire, earth wire, etc., or may be optical ground wire (OPGW), collectively referred to herein as static wire, are supported on the support structures above the conductors. The static wires are electrically grounded, typically on each support structure, directly to the earth to protect the energized conductors from damage caused by lightning strikes.

The harsh weather and lightning strikes may also deteriorate the static wire, which necessitates maintenance or replacement of the static wire with either new static wire or in some cases with optical ground wire or other forms of electrically conductive wires may be used as the static wire.

### SUMMARY

Overhead power line systems employ static wire that may be supported at, or near to, the top of a support structure. Two, or more, lengths of static wire may run substantially parallel to each other on opposite sides of the top center of the support structure. The energized conductors are supported below or between or below and between the static wire or wires. The energized conductors may be referred to as electrified or live. The static wire may be supported on cross-arms, or braces, of the support structure, or on separate arms, mounts etc. which are mounted to the top of the support structure, also collectively referred herein as static wire supports. The static wire supports are often made of metal. The static wire is electrically connected to ground, that is, into the earth by a grounding wire that runs the entire height of the support structure between the static wire and the earth. A length of the energized conductors are supported on a plurality of support structures, spaced apart along the energized conductor. The length of the energized conductors, and corresponding static wire(s), may be great, extending many miles. The static wire providing lightning strike protection for the energized conductors is typically electrically grounded at each support structure. In cases where the static wire is strung as a parallel pair of static wires running the length of the corresponding energized conductors, the Applicant has measured a significant current flow, for example up to 10 amps flowing in the static wires between adjacent support structures, i.e. in a single section of the static wire. For example, in a system of overhead power lines that conduct 345 kV of electricity, the Applicant has measured approximately 6 to 10 amps flowing through sections of the static wires strung between support structures. The Applicant postulates, without wishing to be bound by any particular theory, that circulating currents are formed between two adjacent support structures along the corresponding two parallel lengths of static wire, wherein the current is conducted between the pair of static wires by for example the cross-arms of the support structure on which the static wires are mounted. Furthermore, the voltage difference between the ground wires and the static wires can be up to 16 kV. Both of the significant current that is flowing through the static wires and the voltage differential between the ground wires and the static wires may pose a hazard to workers who are working on the overhead power lines, for example, while they are maintaining or replacing deteriorated static wires.

One aspect of the present invention provides a method of stringing replacement static wires on support structures that support live overhead power lines; that is, that support energized conductors. The present invention provides that the static wire is electrically grounded at substantially each support structure during maintenance and replacement stringing operations so that a lineman may safely handle the static wire without being electrocuted by the potentially high current levels within the static wires and large electrical potential differences between the static wires and the grounding wires.

In one example, the present invention includes or comprises, as those terms are used interchangeably herein, the use of an equal-potential zone at each end of a pull zone to protect the worker, wherein the pull zone defines a length of static wire that is being replaced between two or more support structures.

In another example, the present invention comprises the use of running grounds on static wires that exit and enter, i.e. that are paid-out off or reeled into, the equal-potential zones at either end of the pull zone.

In another example, the present invention may comprise the use of unlined travellers, which ensure that the static wire running through the travellers is electrically connected to the ground of the support structure.

In another example, the present invention comprises the use of a wire rope puller at least at one end of the pull zone.

In another example, the present invention comprises the use of a flexible, insulated, isolation link to separate and electrically isolate the old, to-be-replaced, existing static wire from the wire rope, which eliminates the circulating current between the old static wire and the wire rope.

In another example, the present invention comprises the use of a flexible, insulated, isolation link to separate the new, replacement, static wire from the wire rope, which eliminates the circulating current between the new static wire and the wire rope.

Another example of the present invention may provide a method for stringing static wires within a pull zone of an electrified overhead power line system. The method comprises various steps including providing an electrically insulated connection between a pulling rope and a first end of a length of an old static wire and pulling the length of the old static wire from the pull zone by a second end of the length of the old static wire. A first end of a length of replacement static wire is joined to the pulling rope proximal to the electrically insulated connection. The length of replacement static wire is strung into the pull zone of the system by pulling on the pulling rope while maintaining an electrically grounded connection between earth and the old static wire and while maintaining an electrically grounded connection between the earth and the replacement static wire. The method also includes a step of maintaining an electrically grounded connection between the old static wire and the replacement static wire to substantially each support structure of the system, and therealong to the earth, along the pull zone of the system.

Another example of the present invention may provide a method for stringing static wires within a pull zone of an electrified overhead power line system. The method comprises various steps including providing an isolation link between a pulling rope and a first end of a length of an old static wire and pulling the length of the old static wire from the pull zone by a second end of the length of the old static wire. A first end of a length of replacement static wire is joined to the pulling rope proximal to the electrically insulated connection. The length of replacement static wire is strung into the pull zone of the system by pulling on the pulling rope while maintaining an electrically grounded connection between earth and the old static wire and while maintaining an electrically grounded connection between the earth and the replacement static wire. The method also includes a step of maintaining an electrically grounded connection between the old static wire and the replacement static wire to substantially each support structure of the system, and therealong to the earth, along the pull zone of the system.

Another example of the present invention may provide a system for replacing at least one old static wire that is supported between two or more support towers that also support at least one electrified conductor, the at least one old static wire is electrically connected to earth through a grounding wire at each support structure. This example system may comprise a first puller that is connectible to a first end of the at least one old static wire and that is adapted for pulling the at least one old static wire in a first direction while maintaining an electrical connection between the at least one old static wire and the earth. A second puller that is connectible to a second end of the at least one old static wire and is adapted for pulling the at least one old static wire in a second direction while maintaining an electrical connection between the at least one static wire and the earth. A joint may be provided for removably connecting the second puller to the second end of the at least one old static wire. The joint comprises a grip and an electrically insulated connection. The system may further include a length of replacement static wire that is connectible to the joint. The system may further include a first equal potential zone that is adapted for electrically connecting the first puller to the earth and a second equal potential zone that is adapted for electrically connecting the second puller to the earth.

Another example of the present invention may provide a system for replacing at least one old static wire that is supported between two or more support structures that also support at least one electrified conductor, the at least one old static wire is electrically connected to earth through a grounding wire at each support tower. The system may comprise a first puller that is connectible to a first end of the at least one old static wire and that is adapted for pulling the at least one old static wire in a first direction while maintaining an electrical connection between the at least one old static wire and the earth. A second puller that is connectible to a second end of the at least one old static wire and that is adapted for pulling the at least one old static wire in a second direction while maintaining an electrical connection between the at least one static wire and the earth. A joint may be provided for removably connecting the second puller to the second end of the at least one old static wire, the joint comprising a grip and an electrically insulated connection. The system may further include a length of replacement static wire that is connectible to the joint and a plurality of electrically conductive travellers that are adapted for rotatably supporting the at least one old static wire upon the two or more support structures. The travellers maintain the electrical connection between the at least one old static wire and the earth through the grounding wire at each support tower.

Another example of the present invention may provide a system for replacing at least one old static wire that is supported between two or more support structures that also support at least one electrified conductor, the at least one old static wire is electrically connected to earth through a grounding wire at each support structure. The system may comprise a first puller that is connectible to a first end of the at least one old static wire and that is adapted for pulling the at least one old static wire in a first direction while maintaining an electrical connection between the at least one old static wire and the earth. A second puller that is connectible to a second end of the at least one old static wire and that is adapted for pulling the at least one old static wire in a second direction while maintaining an electrical connection between the at least one static wire and the earth. A joint may be provided for removably connecting the second puller to the second end of the at least one old static wire, the joint comprising a grip and an isolation link. The system may further include a length of replacement static wire that is connectible to the joint.

In summary then, one feature of the present method is the keeping separate of both the old and new static wires and pulling wires with an isolation link so that no circulating current can flow. Another feature is the use of a running ground at each EPZ, thereby protecting each zone. Another feature is using unlined (conductive) travellers to maintain a ground at each support structure, as compared to energized reconductoring where the conductor is insulated from the support structures. In the present method of energized static wire replacement the static wire is grounded at each structure and subject to small circulating currents that can be managed with unlined travellers.

### BRIEF DESCRIPTION OF DRAWINGS

Various examples of the apparatus are described in detail below, with reference to the accompanying drawings. The drawings may not be to scale and some features or elements of the depicted examples may purposely be embellished, or portions removed, for clarity. Similar reference numbers within the drawings refer to similar or identical elements. The drawings are provided only as examples and, therefore, the drawings should be considered illustrative of the present invention and its various aspects, embodiments and options. The drawings should not be considered limiting or restrictive as to the scope of the invention.

FIG. 1 is a front elevation view of an example support structure for supporting conductors and static wires.

FIG. 2 is a top plan view of the example support structures in a section of the line of FIG. 1.

FIG. 3 is a diagrammatic, side elevation view of a system for conducting electrical power by a series of support structures that each support a length of energized conductors and static wires.

FIG. 4 is the diagrammatic, side elevation view of FIG. 3 showing the addition of travellers.

FIG. 5 is the diagrammatic, side elevation view of FIG. 4 showing the installation of two equal-potential zones and two pullers supported thereon.

FIG. 6 is the diagrammatic, side elevation view of FIG. 5 showing the installation of wire tension supports, consisting of a cable sling, hoist, grip and grounding wire in each direction at one support structure.

FIG. 6A is a closer view of the wire tension support of FIG. 6.

FIG. 7 is the diagrammatic, side elevation view of FIG. 6 showing the installation of the wire tension support at a second support structure.

FIG. 8 is the diagrammatic, side elevation view of FIG. 7 showing the joining of a piece of static wire or similar wire to the static wire.

FIG. 9 is the diagrammatic, side elevation view of FIG. 8 showing the joining of a wire rope to the static wire with an isolation link.

FIG. 9A is the diagrammatic, side elevation view of FIG. 8 showing, in an alternative embodiment, the substitution of a length of di-electric pulling rope for the wire rope connected to the static wire.

FIG. 10 is the diagrammatic, side elevation view of FIG. 9 showing a step of pulling the static wire through electrically conductive travellers in a first direction.

FIG. 11 is the diagrammatic, side elevation view of FIG. 10 showing the further pulling of the static wire in the first direction to the end of the pull.

FIG. 12 is the diagrammatic, side elevation view of FIG. 11 showing the installation of the wire tension support to a support structure.

FIG. 13 is the diagrammatic, side elevation view of FIG. 12 showing the installation of another wire tension support to another support structure.

FIG. 14 is the diagrammatic, side elevation view of FIG. 13 showing the joining of replacement static wire to the wire rope.

FIG. 15 is the diagrammatic, side elevation view of FIG. 14 showing the pulling of the replacement static wire in a second direction, substantially opposite to the first direction.

FIG. 16 is the diagrammatic, side elevation view of FIG. 15 showing the further pulling of the replacement static wire in the second direction to the end of the pull.

FIG. 17 is the diagrammatic, side elevation view of FIG. 16 showing the installation of the wire tension support at one support structure.

FIG. 18 is the diagrammatic, side elevation view of FIG. 17 showing the deadending of replacement static wire to support structure and connection of the replacement static wire to a ground wire for a support structure.

FIG. 19 is the diagrammatic, side elevation view of FIG. 18 showing the installation of the wire tension support at another support structure.

FIG. 20 is the diagrammatic, side elevation view of FIG. 19 showing the deadending of replacement static wire to support structure and connection of the replacement static wire to a ground wire for another support structure.

FIG. 21 is the diagrammatic, side elevation view of FIG. 20 showing the permanent connection of the replacement static wire to the support structures.

FIG. 22 is the diagrammatic, side elevation view of the system of FIG. 1 showing two dead-end poles for use with replacement static wire, wherein 200A shows an OPGW deadend and 200B shows a static wire deadend.

FIG. 23 is a side elevation view of one end of an example of a flexible, electrically insulated, isolation link.

FIG. 23A is an enlarged, partially cutaway, view of a portion of FIG. 23.

FIG. 24 is a partially exploded view of the portion of the isolation link of FIG. 23.

FIG. 25 is a side elevation view showing an isolation link passing through a dolly during pulling.

FIG. 26 is an assembled spelter lock as shown used in the spelter socket in the coupling of FIG. 23A.

### DETAILED DESCRIPTION

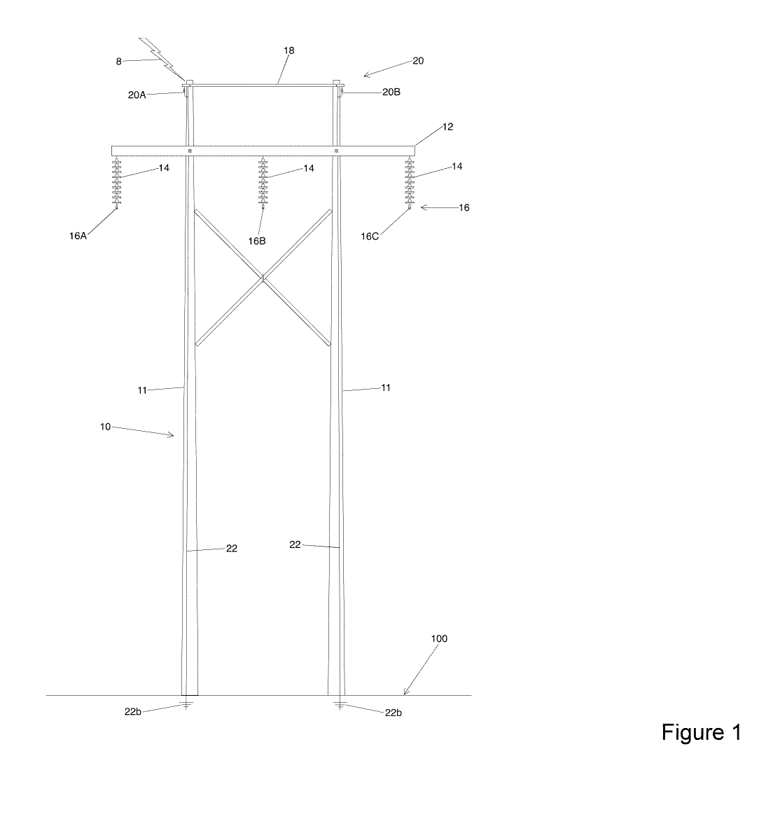

FIG. 1 depicts an example support structure 10. Support structures 10 may also be support poles or pylons or other support structure and are referred to herein collectively as support structures. The support structure 10 is depicted as comprising two support poles 11, but this is not intended to be limiting as support structures 10 may comprise a single support pole, multiple support poles, latticed support towers or combinations thereof as would be known to one skilled in the art. The support structure 10 has a cross arm 12 that supports an insulator or insulators 14 from which an energized conductor 16 is supported. FIG. 1 depicts three phases of conductors 16; namely, conductors 16A, 16B, and 16C. Each conductor 16 is supported by corresponding insulator(s) 14. While FIG. 1 depicts three phases of conductors, this is not intended to be limiting, as there may be one, two, three, or more phases of conductors 16. The conductors 16 when energized conduct high-voltage electricity (for example, above 69 kV or more) for bulk transmission of power from a power plant to both high demand sub-stations and rural sub-stations. The conductors 16 may also be used for distributing medium-voltage electricity (for example, between about 4 kV and about 69 kV) or low-voltage electricity (for example less than 1 kV) electricity from sub-stations throughout a high demand center or a rural area. The methods disclosed herewith are most usefully employed in high-voltage power transmission systems.

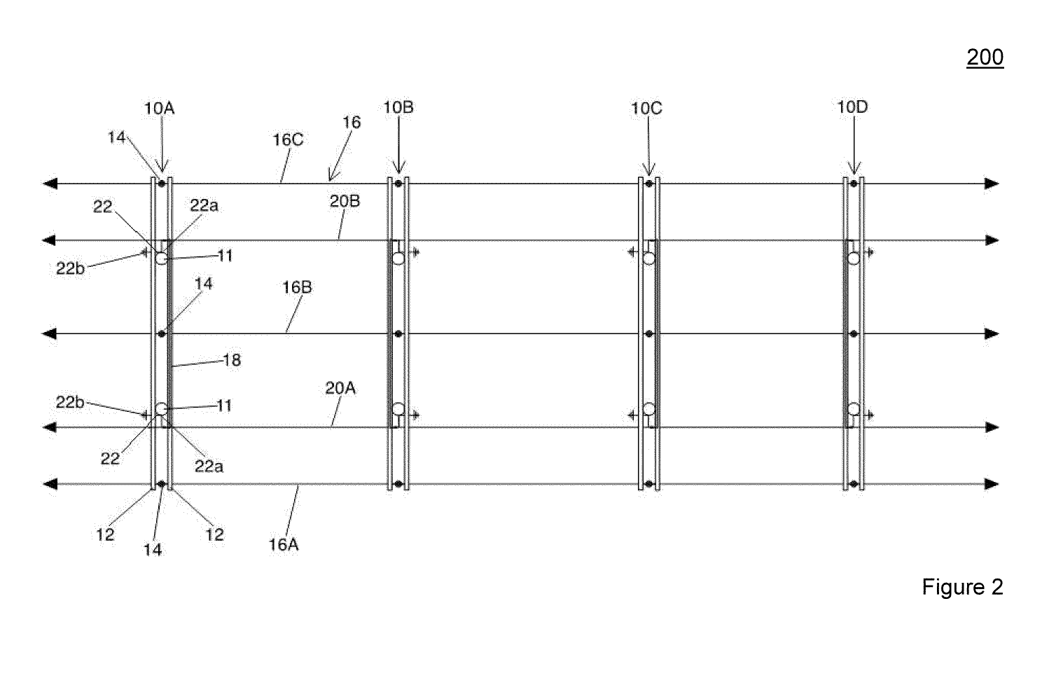

The support structure 10 also supports at least one static wire 20. FIG. 1 depicts two parallel static wires 20A and 20B (also referred to herein as static wires 20A, B) that are positioned above the energized conductors 16; however, one or more static wires 20 may be used. Static wires 20A, B are electrically grounded to the earth 100 by structure grounding wires 22. Static wires 20 A, B may also be referred to as overhead ground wire, earth wire, shield wire, or overhead earth wire. Static wires being replaced may also be optical ground wire (OPGW). Static wires 20A, B are at or near the top of the support structure 10 to protect the energized conductors 16 from lightning strikes 8. As better seen in FIG. 1, the static wires 20A, B may be supported by a static bar 18 associated with each structure 10 as shown in FIG. 2. However, other means of supporting the static wires may also be used. For example, the static wires 20A, B may be supported on the outer edges of an uppermost cross arm 12 of a support structure 10. The static wires 20A, B are grounded to earth 100 by structure grounding wires 22 and grounding connectors 22a electrically connecting a static wire to a structure grounding wire 22. The static wires and their structure grounding wires may thus also ground any faults to earth. The static wires 20A, B may for example be made of stranded galvanized cables or wires, copperweld conductors or alumaweld conductors. As one skilled in the art would appreciate, the static wires 20A, B may also be OPGW that provides conductive protection against lightning strikes provided by static wire so as to protect the conductors 16 and also provides data transmission; e.g. for communications, through optical fibers that are embedded within the conductive casing around the optical fibers in the OPGW. OPGW may also be referred to as optical fiber composite overhead ground wire.

The static bar 18 bonds the static wire 20A to the static wire 20B. In the arrangements where no static bar 18 is used, the static wires 20A, B may be bonded together by other electrically conductive means. For example, the static wires 20A, B may be bonded together by portions or all of the support structure 10, which may be constructed of conductive metal or alloys; or by one or more electrically conductive wires that run across the cross arm 12; or by electrically conductive bracing that contacts two corresponding support structures; or by a wire run from the top of one support structure 10 to which one static wire is mounted to another; or combinations thereof.

The static wire 20 may be connected to the support structure 10 by releasable static wire clamps (not shown) that support the weight of the static wire 20.

The structure grounding wires 22 run from the static wires 20 to the bottom of the support structure 10, for example down along poles 11 to where and they are electrically grounded in the earth 100 by earth connections 22 b which may be ground rods or butt plates.

FIG. 2 depicts a top plan view of a section of an overhead energized power line system 200 that comprises a series, that is, a spaced apart array, of support structures 10A, B, C and D. The overhead power line system 200 conducts electrical power from one place to another. The support structures 10A, B, C and D one essentially the same as described above for the support structure 10. While FIG. 2 depicts four support structures 10A, B, C and D, it is understood that the system 200 may comprise any number of support structures and their spacing from one another may vary depending upon the distance and terrain that the system 200 spans and other factors as would be known to one skilled in the art.

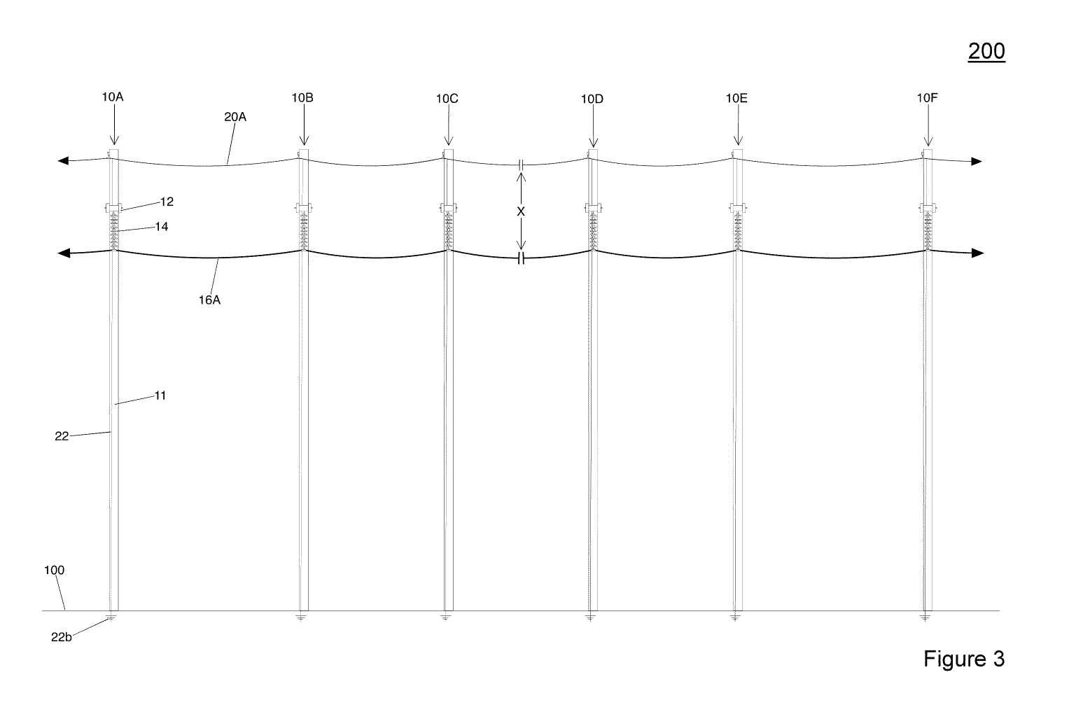

FIG. 3 depicts a side elevation view of a longer section of the system 200 which includes support structures 10A, B, C, and D of FIG. 2, and further support structure 10E and 10F, all of which comprise the same features as described above for support structure 10. FIG. 3 includes two break lines X, which indicate that a there may be one or more further support structures 10 positioned within the system 200, between support structures 10C and 10D for supporting further lengths of energized conductor 16 and static wire 20.

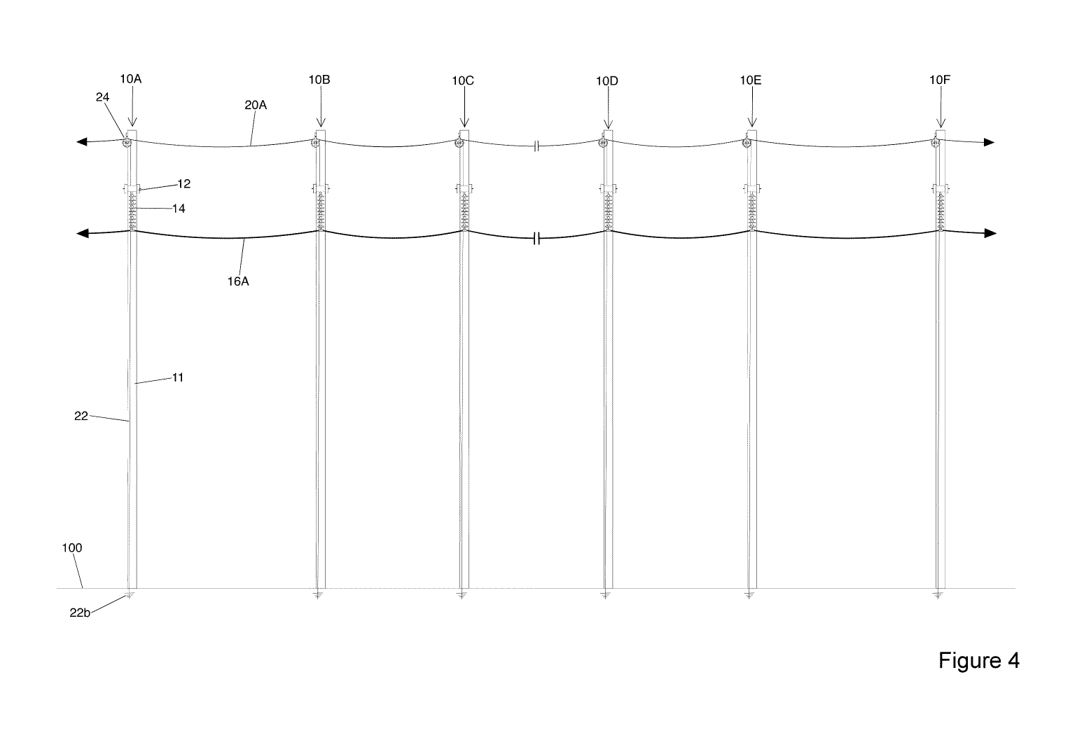

FIG. 4 is the same view as FIG. 3 with the addition of at least one traveller 24 at or near the level where the static wires 20 A, B are supported on each support structure 10. For example, the traveller 24 may be connected to the ends of the static bar 18. The traveller 24 may also be referred to as a stringing traveller or dolly, and those terms are used interchangeable herein. The traveler 24 is a pulley-like device that assists in the stringing by allowing a conductor 16, a static wire 20, or for example a pulling rope 46 (not shown in FIG. 4) or whatever element is being strung into the system 200 to be supported by the support structure 10 but while still being able to move through the system 200. The traveller 24 comprises a wheel that is rotatably connected to a frame that is removably mounted to the support structure 10. The wheel supports the weight of a wire as it is pulled through the traveller 24 while the wire is being strung to a support structure 10. Conventionally the wheel of the traveller 24 may be lined with a non-conductive liner, such as a neoprene liner or a rubber liner. The inventors have observed that the non-conductive liners in such travellers may burn due to the induced current and voltage within the static wire 20, which in turn damages the static wire 20. Preferably, in the present invention the traveller 24 is not lined with any non-conductive material, which may also be referred to as unlined, and is itself made or electrically conductive material, for example, the wheel may be of metal such as of polished aluminum. While FIG. 4 only depicts one traveller 24 upon each support structure 10, it is understood that there is at least one traveller 24 on each structure 10 for each static wire 20 that may be in use in the system 200. The use of a parallel pair of static wires 20 above the energized conductors 16 is, again, shown by way of example only as other static wire arrangements above the energized conductors 16 would also work.

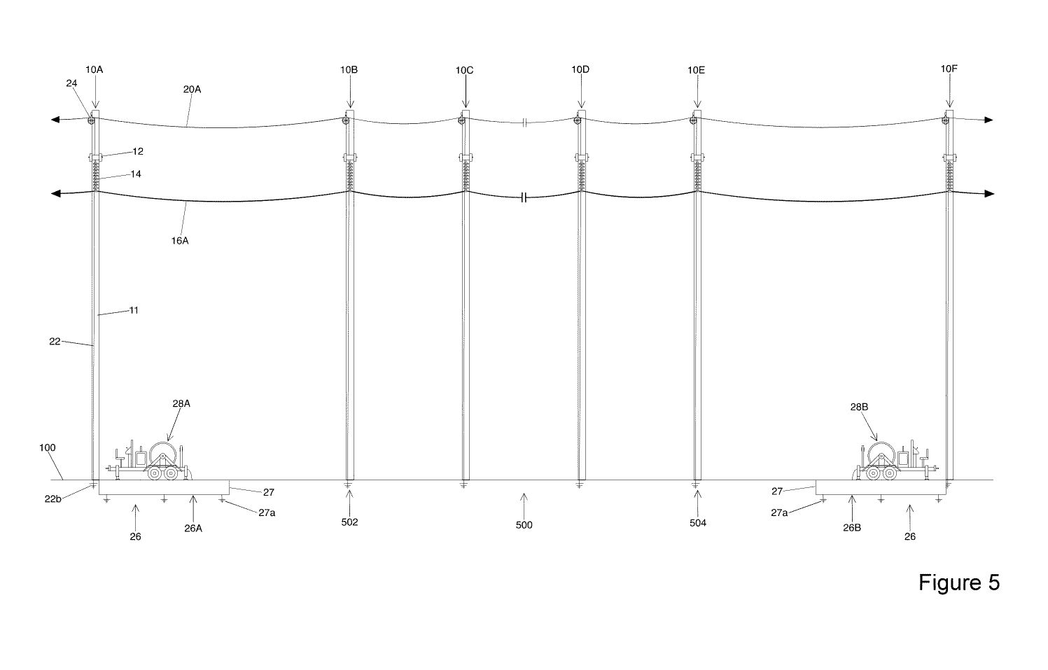

FIG. 5 depicts an installation of an equal-potential zone (EPZ) 26A, B and a puller 28A, B at each end of a pull zone 500. The pull zone 500 is a portion of the system 200 where the static wire 20 will be replaced. As described in U.S. Pat. No. 7,535,132, the disclosure of which is incorporated herein by reference in its entirety, the EPZ 26 brings workers to the same electrical potential as the lines that they are working on. When workers and equipment are at the same electrical potential as the conductor, the conductor can be worked without the need for keeping the workers insulated from the conductor. Using the EPZ 26 is one way of keeping workers and conductors at the same potential so as to protect the workers.

The EPZ 26 may include at least one mat 27 that is located on the ground. A mat 27 may comprise one large mat or multiple smaller mats that are electrically bonded together and to ground. Workers and the equipment they will be using are located on the EPZ 26. All equipment and wires or conductors currently being worked on are electrically bonded to the EPZ 26, which in turn, is connected to ground. In the event that a conductor changes in potential, everything upon the EPZ 26, including personnel, raises or lowers in voltage equal to the conductor so that there are no differences in potential between them.

Eliminating differences in potential between workers, equipment and conductors protects workers from currents that may flow between differences in potential. Energized conductors create an electromagnetic field around them, and stringing a wire, such as a static wire 20, in close proximity to that electromagnetic field induces a voltage in the wire being strung. Thus, even if the static wire 20 is not connected to a power source, it may have a significant electrical potential. The EPZ 26 also protects the workers from induced voltage and current that may occur on the static wire 20 when stringing in close proximity to energized conductors 16. However, when all stringing equipment and conductors being worked on are bonded to the EPZ 26 and to ground, the potential is the same between workers the equipment and the wire or conductor being worked on.

Each mat 27 is electrically grounded to the earth as illustrated by grounds 27a. Surrounding a perimeter of the mat 27 is at least one fence, but preferably, two spaced apart fences that control access to the mat (not shown). The mat 27 is preferably made of metal mesh fencing where the mesh is bonded together solid strands that are rigid or semi-rigid, but not loose such as chain link. Alternatively, the mat 27 can be vinyl mats with copper braiding sewn into them, thus providing an electrical connection around and through each mat 27. If prefabricated fencing is used, the fencing pieces are electrically may be bonded together using a #2 ASCR conductor or similar conductor. Several mats 27 of metal fencing may be electrically bonded together to create an EPZ 26.

The puller 28 is positioned on the mat 27 of the EPZ 26 and it is electrically bonded to the EPZ 26 and to ground. The puller 28 comprises a reel that may or may not be rotated by a motor. The reel of the puller 28 stores lengths of wire. For example, the puller 28 may be a V-groove puller, or other design of wire rope puller or wire puller. The pull zone 500 has a first end 502 and a second end 504 opposite the first end 502. A length of old static wire 20′ that will be removed and replaced by replacement static wire 20′″ runs the length of the pull zone 500. The phrase “old static wire” is used herein to refer to a length of existing static wire that is already strung within the system 200 and will be replaced for whatever reason. The phrase “old static wire” is not a reference to and should not be limited to an amount of time that the existing static wire has been strung within the system 200. While FIG. 5 depicts support structures 10B, C, D and E as being within the pull zone 500, there may be more or less support structures 10 that fall within the pull zone 500.

The EPZ 26A and the puller 28A are positioned at the opposite second end of 504 the pull zone 500 from the EPZ 26B and the puller 28B which are positioned at the first end 502. In particular the EPZ 26A and the puller 28A are positioned adjacent to the first end 502 of the pull zone 500 and the EPZ 26B and the puller 26B are positioned adjacent to the second end 504. These positions are interchangeable and are not to be considered limiting or restricted to the arrangement illustrated as the illustration is diagrammatic and by way of example as other configurations would work so long as stringing of replacement static wire is enabled. In the following description of the method to replace the old static wire 20′, pulling is defined in a first direction towards the first end 502, and defined in a second direction towards the second end 504. During the method, one puller, for example, puller 28A may be contributing that is paying out, new static wire to the system 200 from a reel on puller 28A. This may be referred to as a pay-out puller. The other puller, for example puller 28B, may have a reel that is removing or taking-up old static wire from the system. This may be referred to as a take-up puller. A pay-out puller may be positioned at or near a pay-out end of the pull zone 500, which may be either of the ends 502, 504. A take-up puller may be positioned at or near a take-out end of the pull zone 500, which may be either of ends 502, 504 or opposite to the pay-out end. In FIG. 5, the puller 28A is the take-up puller and the puller 28B is the pay-out puller. However, during the method each of pullers 28A, B may be both a take-up puller and a pay-out puller.

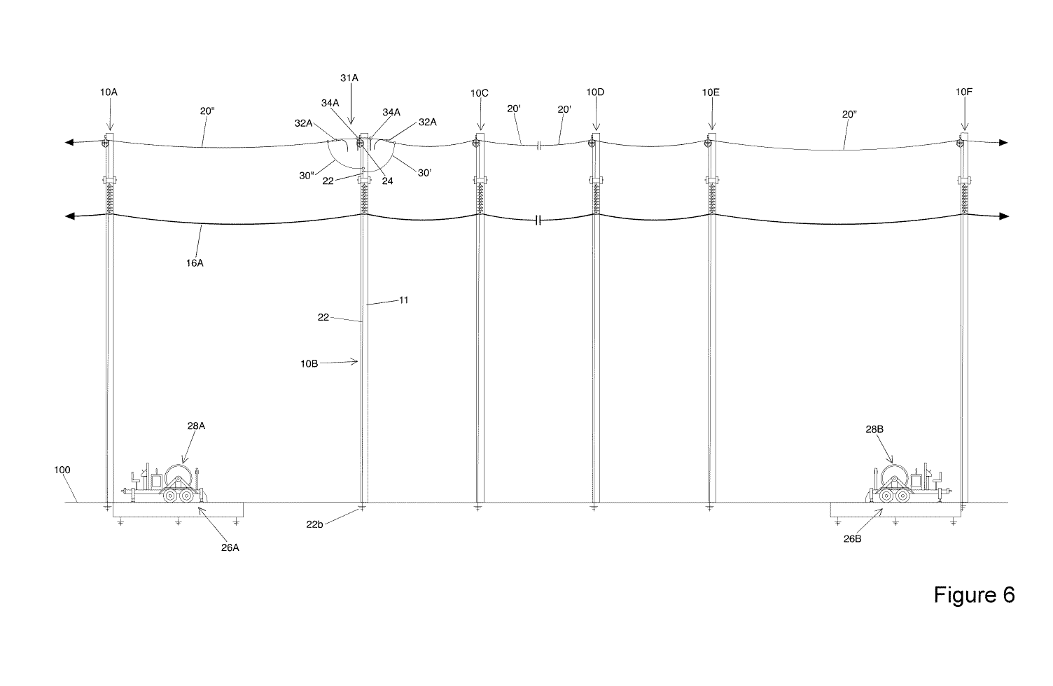

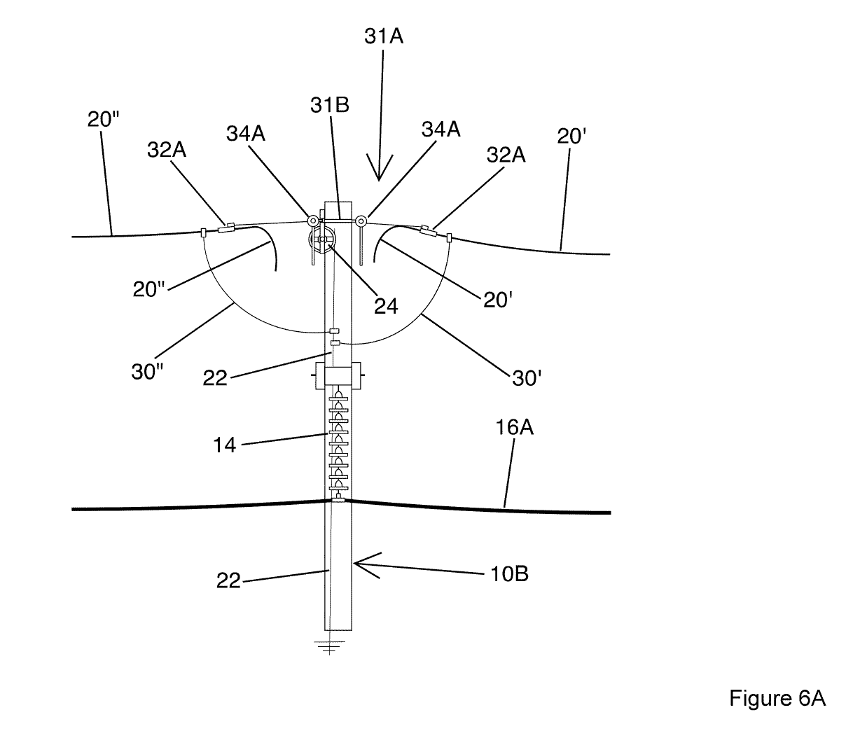

FIGS. 6 and 6A depict an installation of the wire tension support 31A to support structure 10B. The wire tension support 31A comprises a cable sling 31B, grip 32A and a hoist 34A. The grip 32A, which may also be referred to as a wire grip, is a type of clamp that supports the tension of the wire. Typically, the design of a grip is such that increasing a tension force that is applied to the grip 32A will increase the gripping force it applies to the wire it is holding on to. The hoist 34A, which may also be referred to as a chain hoist, is used to take up the tension within a wire that the grip 32A of the wire tension support 31A is connected to. As better seen in FIG. 6A with the tension in the static wire being taken up by the cable sling, the hoist and grip to the static wire 20 is cut at or near support structure 10B, i.e., between the grip and the structure, in preparation for being pulled out. The section of static wire 20 that is being replaced is referred to herein as old or replaced static wire 20′. The section of the static wire that is not being replaced, i.e. which is to remain in place, is referred to herein as static wire 20″. A grip 32A and corresponding hoist 34A and cable sling is connected to each of the old static wire 20′ and the static wire 20″ so as to take the tension on the structure, in this case structure 10B. With both of the static wires 20′, 20″ electrically connected to the static grounding wire 22 of the support structure 10B by grounding wires 30′, 30″ respectively the wires 20′ and 20″ are severed so as to leave their free ends hanging down between the grips. Guy wires (not shown) may be used to support the structure as necessary to support the tension of either or both of the static wires 20′, 20″.

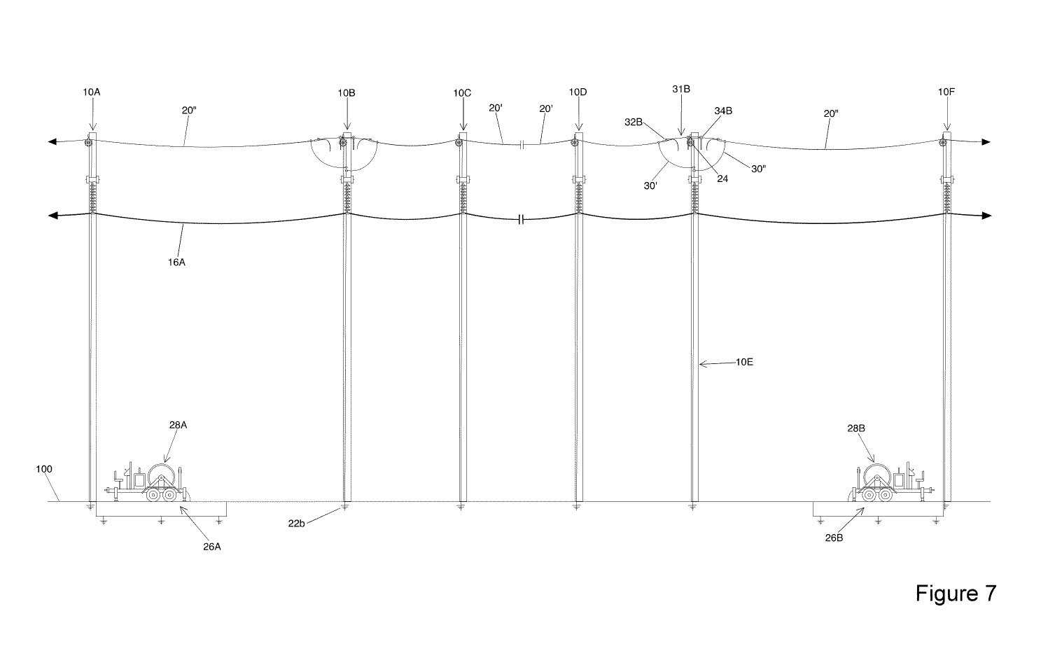

FIG. 7 depicts an installation of the wire tension support 31B to support structure 10E. The wire tension support 31B also comprises a grip 32B and a hoist 34B and a cable sling for each free end of static wires 20′ and 20″ once the static wire 20 is cut at or near the support structure 10E. The static wires 20′, 20″ are electrically connected to the static grounding wire 22 of the support structure 10E by grounds 30′, 30″ respectively.

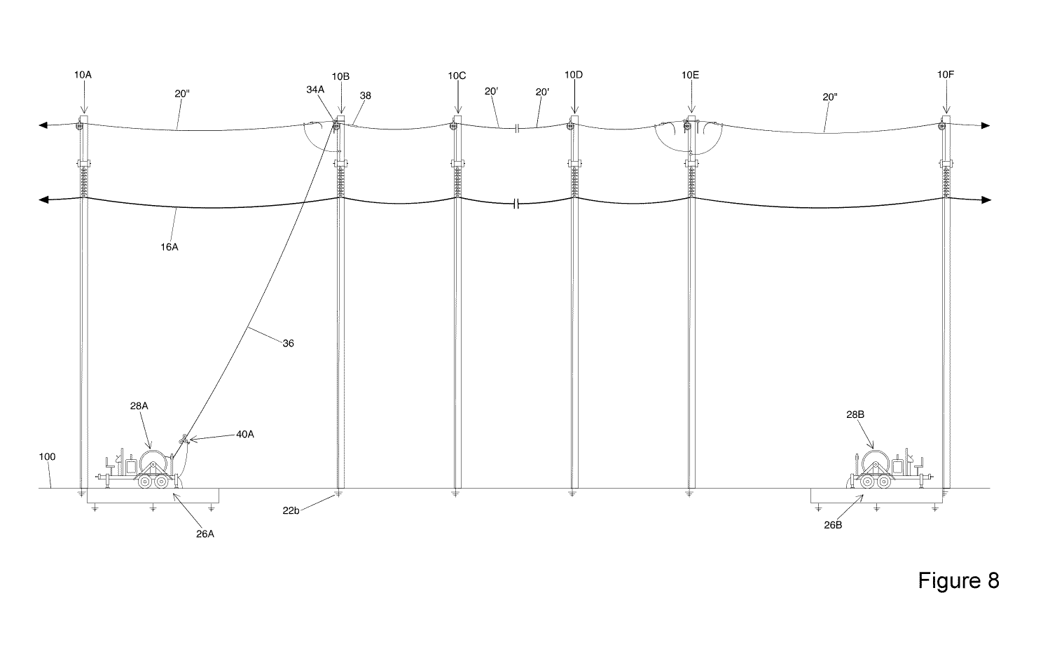

FIG. 8 depicts a joining of a wire 36, for example an old piece of static wire, from the puller 28A to the free end of the old static wire 20′ by a joint 38. As illustrated, the joint 38 may be initially installed proximal to support structure 10B once the tail of wire 36 is fed through traveller 24. The joint 38 may comprise a grip, such as a Kellum grip, back-to-back Kellum grips, one or more wire preforms or combinations thereof. A Kellum grip may also be referred to as a pulling sock. The grip is a mechanical device that permits two lines such as wire, rope, cables, conductors 16, static wire 20 to be connected end to end and it is configured so that if more tension is placed on the two lines that the grip connects, the tighter the grip holds. The grip may be made of woven wire and it provides a mechanical connection between the wire 36 and the old static wire 20′. The tension across the newly joined wires 20′, 36 is taken up by the puller 28A until the hoist 34A becomes slack. At this point, the hoist 34A and its corresponding grip 32A is removed from the old static wire 20′. A running ground 40A is installed on the conductor wire 36, for example proximal to the puller 28A. The running ground 40A allows the wire 36 to be pulled in the first direction y or in the second direction z, while maintaining a grounded electrical connection between wire 36 and the EPZ 26A.

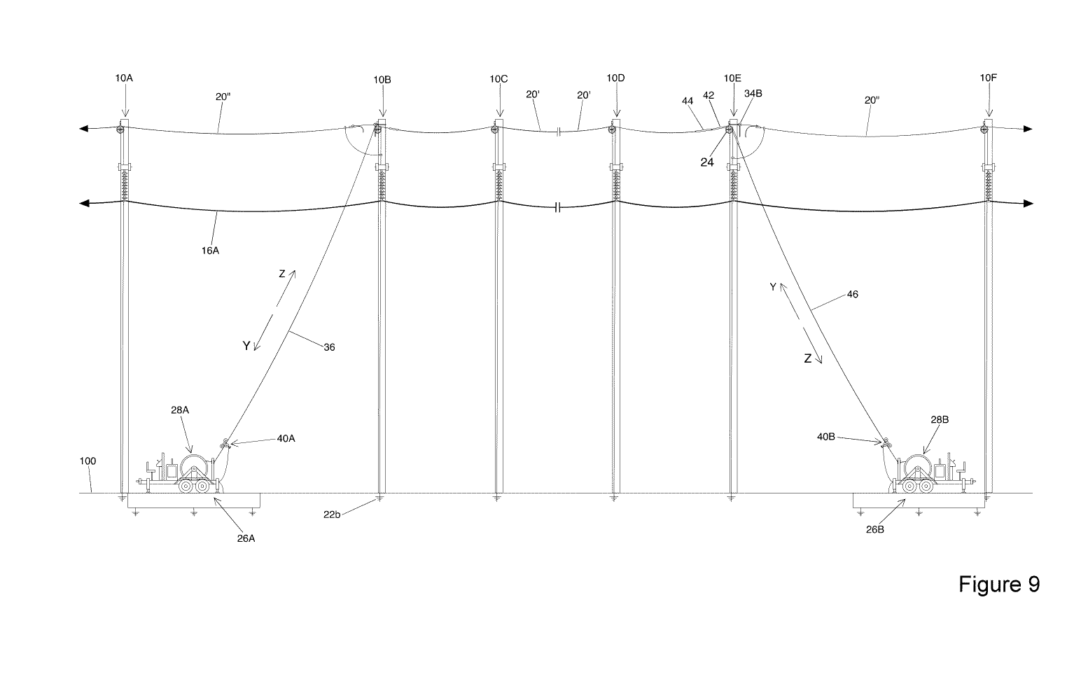

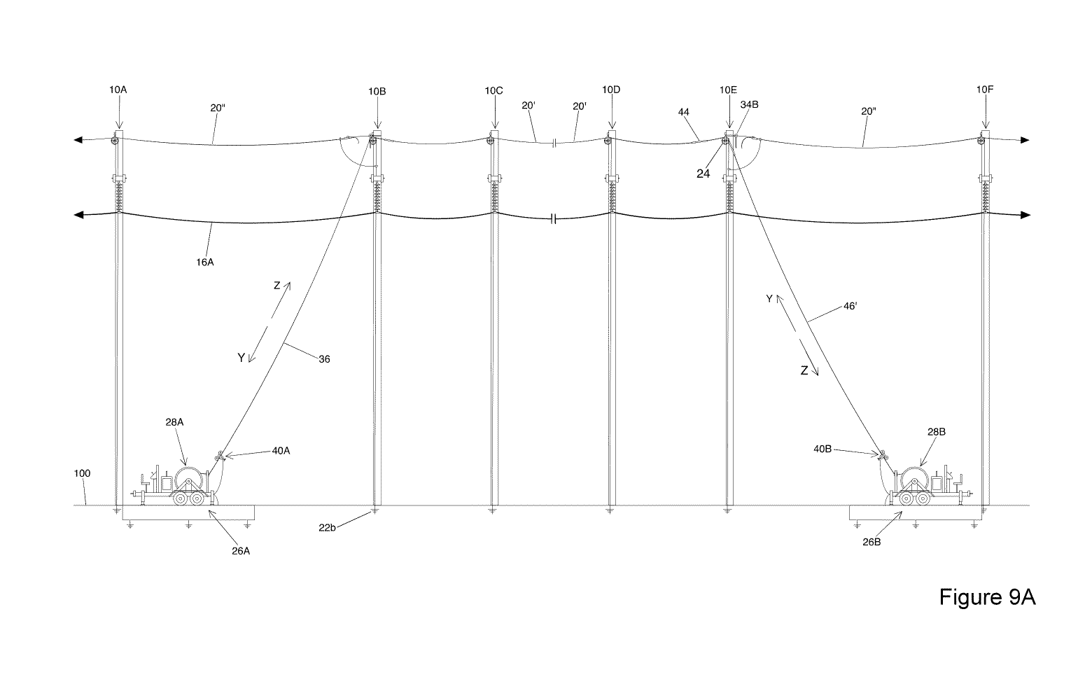

FIG. 9 depicts a joining of a flexible pulling member, which may for example be wire rope 46, to the old static wire 20′. The wire rope 46 may also be referred to as a pulling wire. The pulling wire 46 is paid out in direction y from the reel on puller 28B. The tail or free end of the pulling wire 46 is pulled up and through the traveller 24 on the support structure 10E. The free end of the pulling wire 46 may be joined to one end of a joint 44 either before or after the pulling wire 46 is pulled through the traveller 24. The joint 44 may comprise a grip and an isolation link 42. The grip of the joint 44 may be a Kellum grip, back-to-back Kellum grips, one or more wire preforms or combinations thereof. The grip may be made of woven wire and it provides a mechanical connection between the pulling wire 46 and the old static wire 20′.

In the alternative embodiment of FIG. 9A, isolation link 42 and at least a length of wire rope 46 is replaced with dielectric or non-electrically conductive pulling rope 46′. The static wire, either the existing static wire to be replaced or the new replacement static wire, is connected to dielectric pulling rope 46′ at joint 44.

The isolation link 42 is a flexible, preferably weather-proof, electrical insulator having the properties that it not only does not conduct electric current, but also will carry a tensile loading and also preferably allow for swivelling of at least one end of the link to relieve torque loading on the end of the link due to any torque applied to the link from the pulling wire 46. For example, the isolation link 42 may be a length of tensile and dielectrically tested insulated rope with dielectric properties, preferably protected or shielded from the weather or other adverse elements that may compromise its dielectric properties. Although a pulling rope may be employed in good weather instead of a wire rope 46, it is in applicant's opinion prudent to use an isolation link 42 in those situations also, in case of inadvertent deterioration of the rope's dielectric properties due to moisture, contamination, etc. Applicant has found that high voltage levels in the energized conductors, which have been found to induce a voltage and current in the static wires, when combined with the adverse effect on the dielectric properties of a pulling rope due to moisture and/or dirt, etc. in or on the pulling rope may cause the pulling rope to melt and break/fail. The isolation link 42 electrically isolates a pulling rope or a pulling wire 46, and the associated workers and the stringing equipment on the corresponding EPZ 26 as the pulling wire 46 is strung through the system 200. The other end of the isolation link 42 is joined to the corresponding end of old static wire 20′ by the grip of the joint 44.

One example of an isolation link 42 proposed by the applicant uses a length of dielectric rope which is encased in a flexible membrane, wherein the membrane is filled with dielectric oil so as to impregnate the dielectric rope and exclude air in the interstices between the fibres of the rope and in any voids between the rope and the membrane. In one embodiment, each end of the isolation link, its length depending on the required insulation between the pulling wire 46 and the static wire 20′ as would be known to one skilled in the art, is sealed to maintain the oil in the membrane and rope and mounted in a terminating device to a joint such as a ball joint and/or swivel joint, etc., so as to resist a tensile force applied to the link and allow relative motion between the end of the sealed membrane/rope combination and the end of the pulling wire 46 or end of the static wire 20′ as the case may be. A more complete description of an example of an isolation link is provided below, at the end of this descriptive portion of the specification. A further description is provided in applicant's U.S. provisional patent application No. 61/968,543, entitled Flexible Isolation Device for Wire Stringing, filed Mar. 21, 2014, which is included herein in its entirety by reference, and to which this application claims priority in part.

The puller 28B is used to take up the tension across the newly joined wires 20′, 46 and link 42 until the hoist 34B becomes slack. The hoist 34B and its corresponding grip is removed and a running ground 40B is installed on the pulling wire 46, for example proximal to the puller 28B. The running ground 40B allows the pulling wire 46 to be pulled in the first or second direction y, z respectfully while maintaining a grounded electrical connection with the EPZ 26B.

One skilled in the art will appreciate that the isolation link 42 provides an electrically insulated connection between the old static wire 20′ and the pulling wire 46 that breaks an electrical circuit, such as a ground circulating current, that can circulate between the two EPZs 26 A, B, through the earth 100 and along the old static wire 20′ and pulling wire 46.

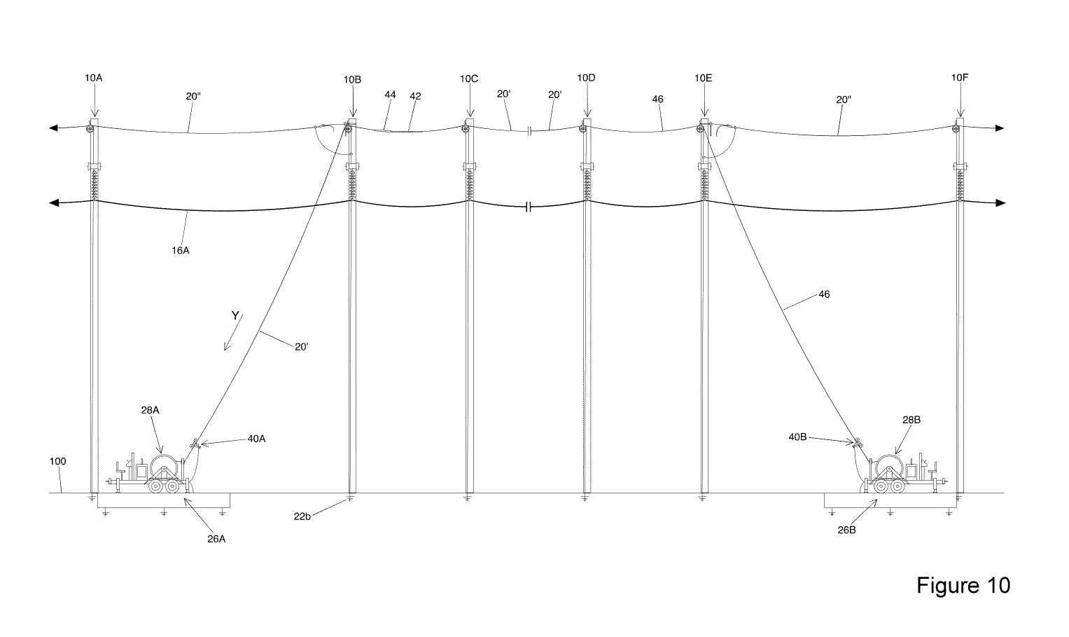

FIG. 10 depicts a pulling of the static wire 20′ in the first direction y by and towards the puller 28A. As seen in FIG. 10 the isolation link 42, the joint 44, and the pulling wire 46 are depicted as being between the support structures 10B and 10C (whereas in FIG. 9 the isolation link 42, the joint 44, and the pulling wire 46 were shown between support structures 10D and 10E. As the static wire 20′ moves in the first direction y, it is removed from the system 200 by a take-up reel on puller 28A. At the same time, further pulling wire 46 is being paid out, i.e. added into the system 200 by a pay-out reel on puller 28B.

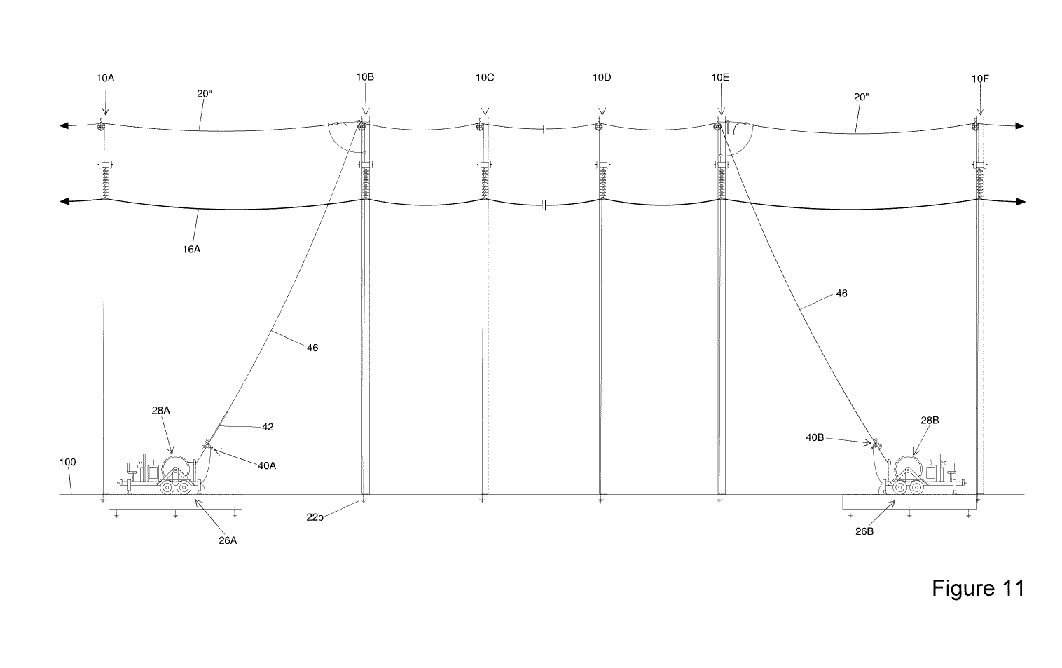

FIG. 11 depicts the further advancement of the pulling wire 46 in the first direction y. As seen in FIG. 11 the isolation link 42, the joint 44, and the pulling wire 46 are depicted as having advanced in direction y so as to extend between the support structures 10A and 10B, with link 42 proximal to puller 28A (end of the pull).

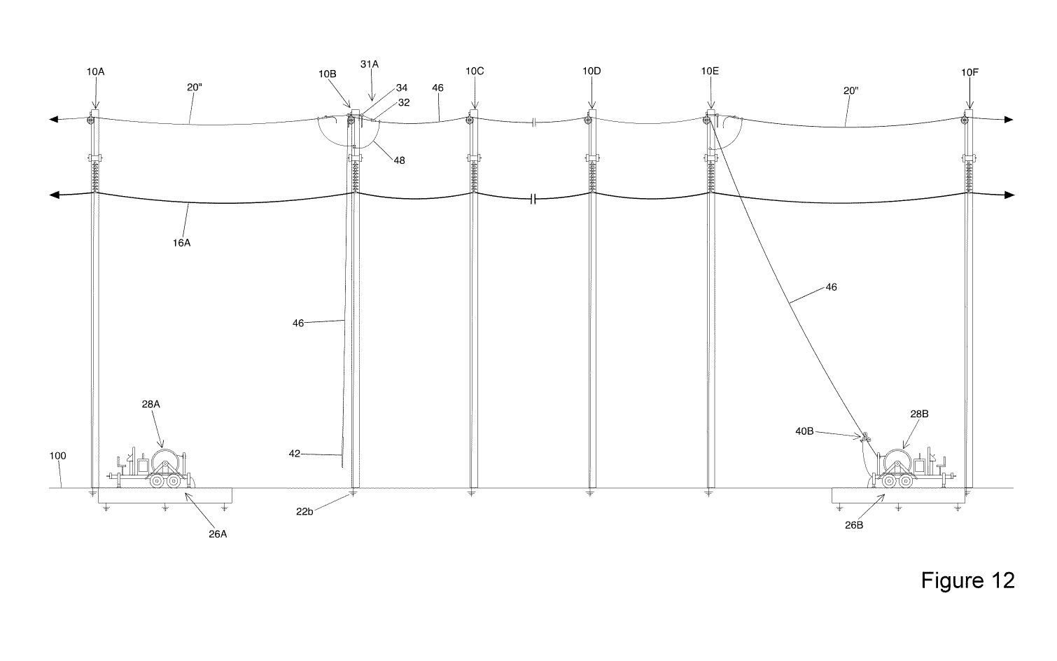

FIG. 12 depicts an installation of a wire tension support 31A to the support structure 10B so as to transfer the tension in pulling wire 46 to structure 10B. The grip 32 is connected to pulling wire 46 and the tension taken up by hoist 34. A ground wire 48 electrically connects the pulling wire 46 to the static grounding 22 of the support structure 10B. The joint 44 is disabled to disconnect the old static wire 20′ from the isolation link 42 and the remaining static wire 20′ reeled onto the take-up reel on puller 26A. At this point, the old static wire 20′ has been completely wound up on the take-up reel of puller 28A so that all of the original static wire 20′ within the pull zone 500 has been removed. The puller 28A may then be removed from the EPZ 26A.

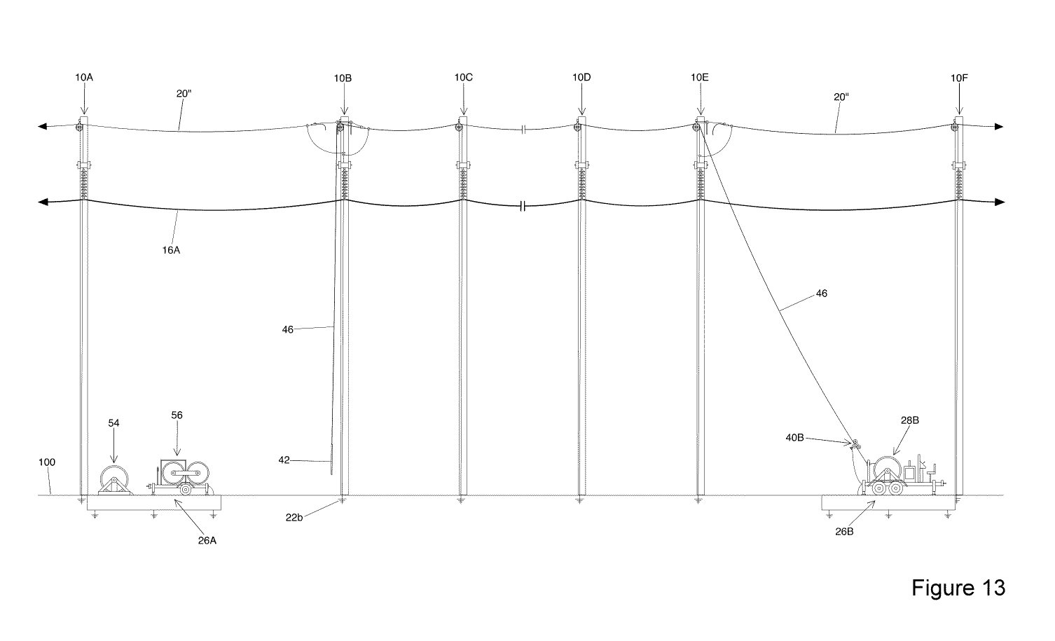

FIG. 13 depicts an installation of both a pay-out reel 54 containing replacement new static wire 20′″ and a tensioner 56 on the EPZ 26A. The pay-out reel 54 may be a reel stand or a reel trailer that includes a length of replacement static wire 20′″ that is at least long enough to replace the old static wire 20′ that was removed from the pull zone 500. The tensioner 56 controls the tension across the static wire 20′″ while the static wire 20′″ is being strung in the second direction z through the pull zone 500. The tension of the static wire 20′″ is maintained a level to prevent the static wire 20′″ from contacting the earth 100 or any of the energized conductors 16A, B, C. The tensioner 56 may act as a brake on the pay-out reel 54 that is paying out the replacement static wire 20′″. Optionally, the replacement static wire 20′″ may be OPGW or non-OPGW such as conventional conductor wire. At this step in the process the end of the pull zone 500 that is closest to the EPZ 26A may be referred to as the pay-out end of the pull zone 500 while the replacement static wire 20′″ is pulled through the pull zone 500 in direction z, and the end of the pull zone 500 that is closest to the EPZ 26B may be referred to as the take-off end of the pull zone 500.

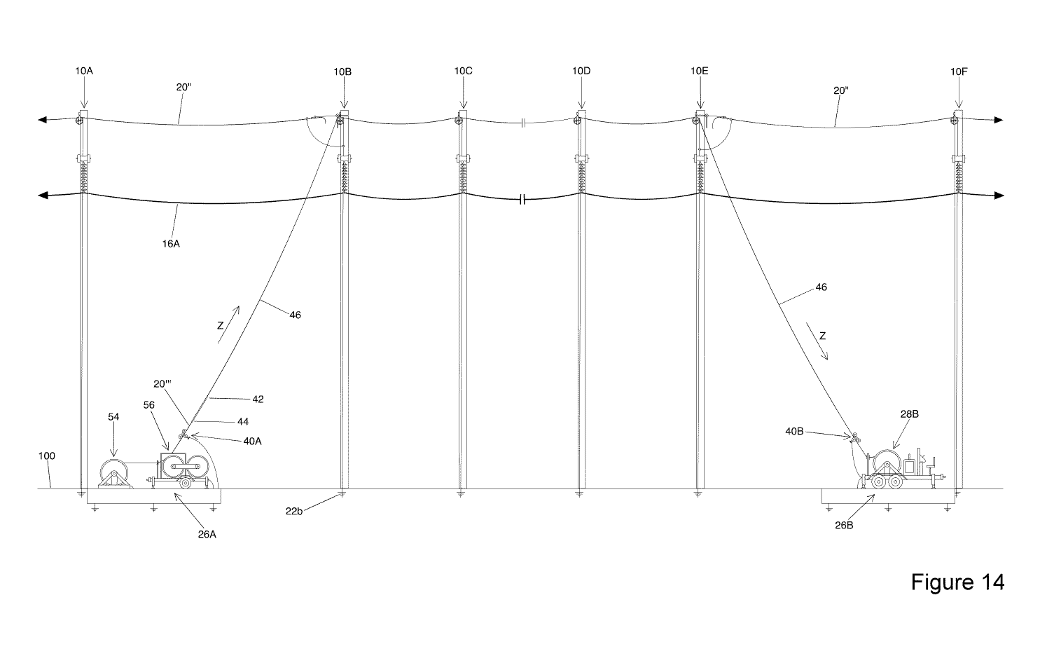

FIG. 14 depicts a joining of the replacement static wire 20′″ to the pulling wire 46 by the joint 44 and isolation link 42. A running ground 40 is installed on the replacement wire 20′″. The wire tension support 31A is removed from the pulling wire 46 at the support structure 10B as is the connection between the pulling wire 46 and the static grounding 22 of the support structure 10B.

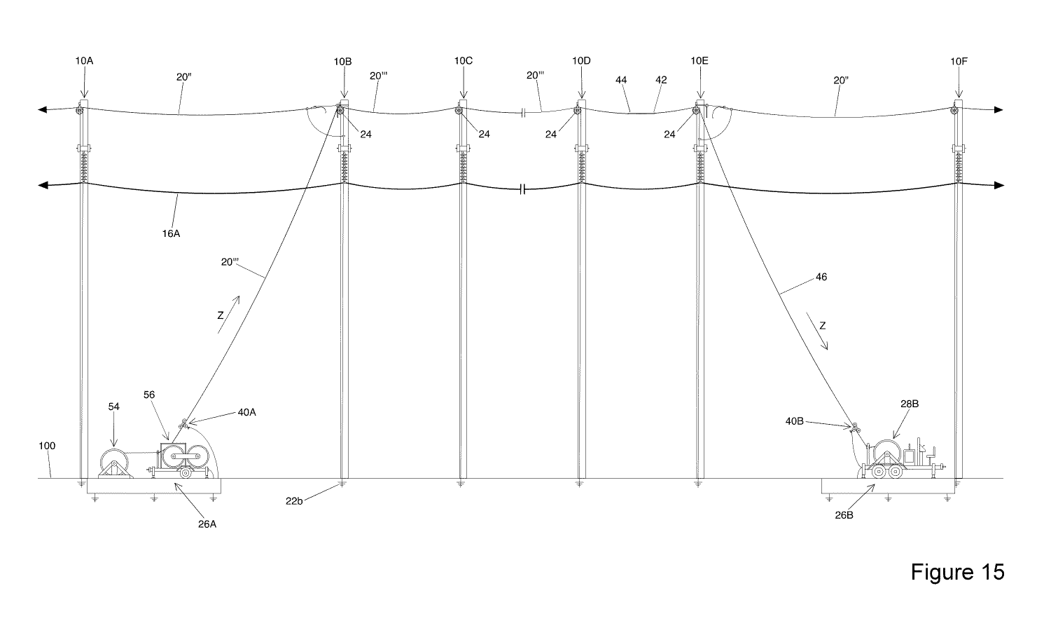

FIG. 15 depicts a pulling of the replacement static wire 20′″ in the second direction z by the puller 28B. This pulling step may also be referred to as stringing the replacement wire 20′″ through the pull zone 500. For example, in FIG. 15 the joint 46 and the isolation link 42 are depicted as being advanced in direction z so as to be positioned between the support structures 10D,E that between the support structures 10B, C, as in FIG. 14. The puller 28B removes the pulling wire 46 from the system 200 by wrapping the pulling wire 46 around a take-up reel. The puller 28A is adding, i.e. stringing, replacement static wire 20′″ into the system 200 by paying out replacement static wire 20′″ from the pay-out reel 54. As the replacement static wire 20′″ is pulled in the second direction z, it is supported by the rotating wheel of the travellers 24 on each support structures 10 within the pull zone 500.

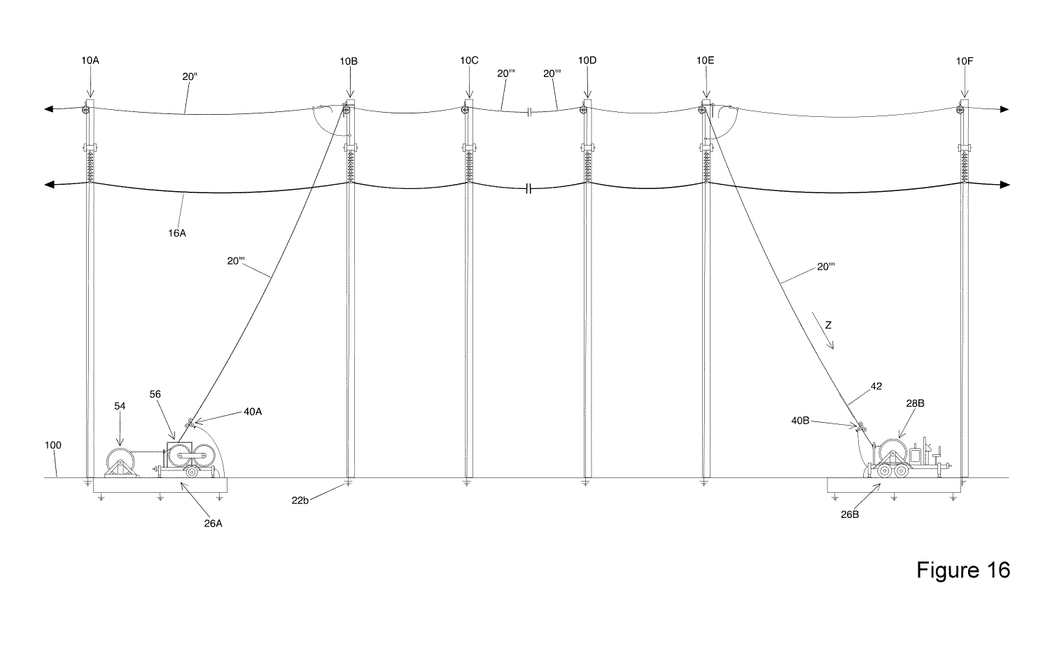

FIG. 16 depicts an advancement of the replacement static wire 20′″ in the second direction through the pull zone 500. In FIG. 16, the replacement static wire 20′″ has been pulled by the puller 28B to a position past the traveller 24 on the support structure 10E.

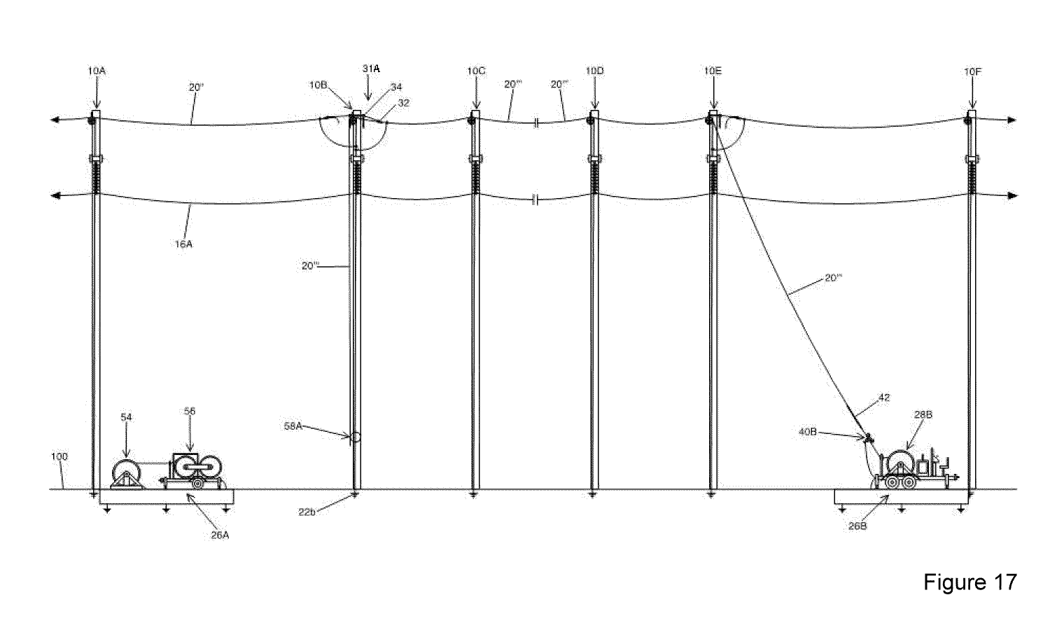

FIG. 17 depicts a grounding of the replacement static wire 20′″ at the pay-out end of the pull zone 500, for example at the support structure 10B. A cable sling 31B a grip 32 and a hoist 34 are connected to the replacement static wire 20′″ to maintain the tension of the replacement static wire 20′″. The tensioner 56 is then released to relieve the tension in the replacement static wire 20′″ between the tensioner 56 and the support structure 10B. In the option where the replacement static wire 20′″ is OPGW, enough OPGW is paid out from the puller 28A to be cut and allow the OPGW to be wrapped in a coil 58A at the base of the support structure 10B. For example, one end of the OPGW may be secured close to or at the base of support structure 10B. In the option where the replacement static wire 20′″ is not OPGW, the static wire is cut at the top of the support 10B and the tail of the wire is lowered to the earth 100. OPGW may be secured and stored, that is, wrapped at the base of the structure as depicted to provide ease of access to the fiber optics for the later installation of data transfer equipment. The replacement static wire 20′″ is electrically connected to the structure grounding wire 22 of the support structure 10B by a ground wire 48. At this point, the replacement static wire 20′″ is grounded and secured to the pay-out end of the pull zone 500, for example at support structure 10B, while maintaining the tension across the replacement static wire 20′″ through the pull zone 500.

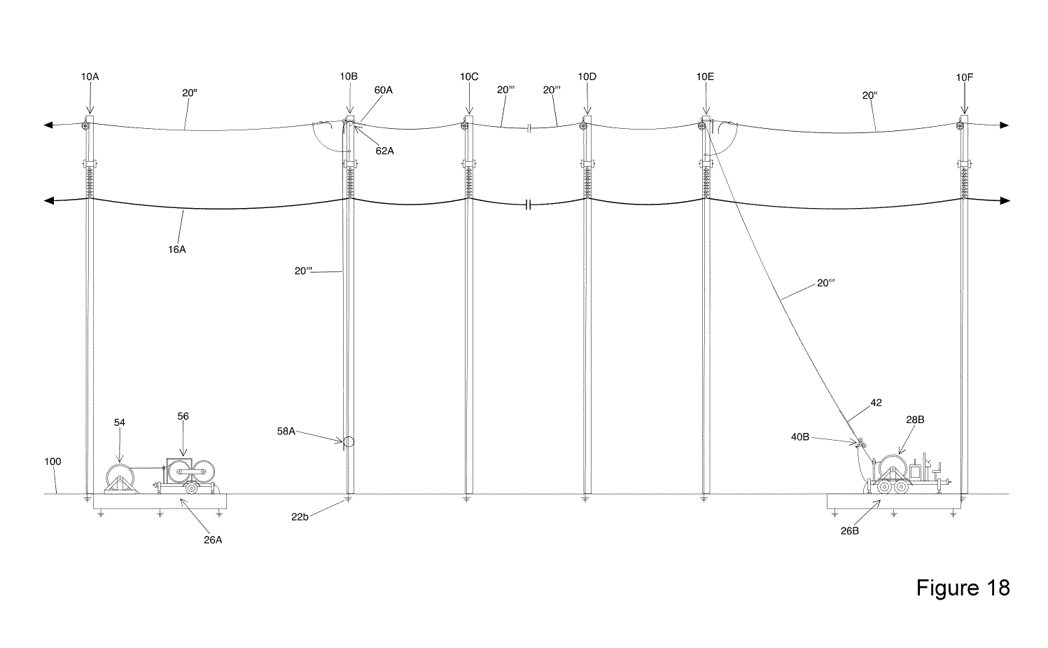

FIG. 18 depicts an installation of a deadend 60A on the replacement static wire 20′″ at the pay-out end of the pull zone 500, for example at the support structure 10B. The deadend 60A permanently supports the tension of the replacement static wire 20″ and is electrically connected to the structure grounding wire 22. The traveller 24, the cable sling 31B, the grip 32, the hoist 34 and the ground wire 48 may now be removed from the pay-out end of the pull zone 500. For example, these features may be removed from the support structure 10B.

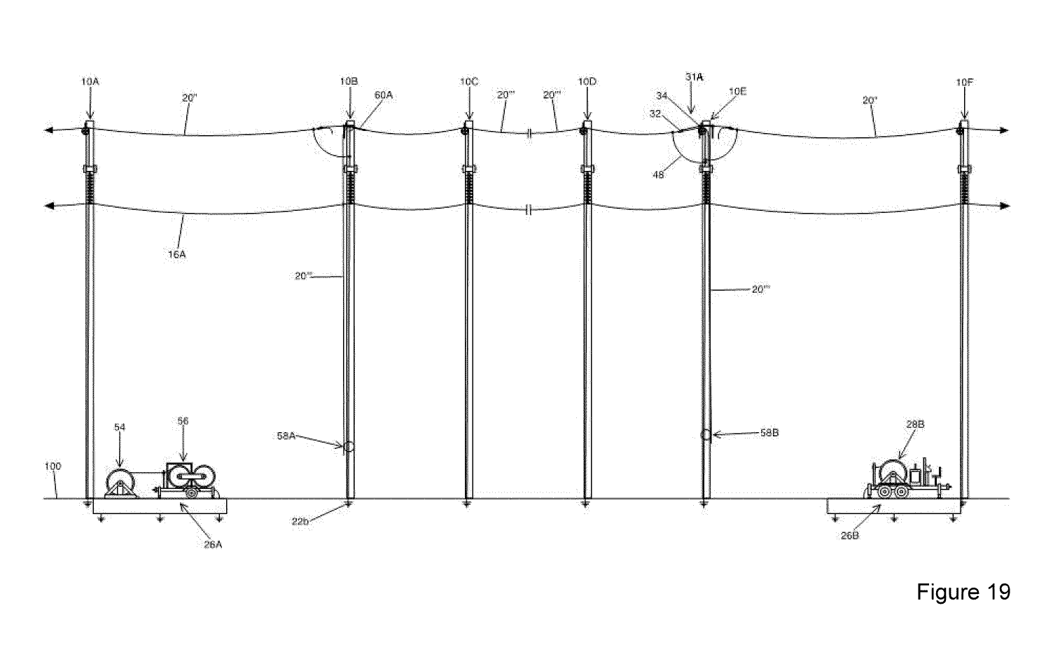

FIG. 19 depicts a grounding 48 of the replacement static wire 20′″ at the take-off end of the pull zone 500, for example at the support structure 10E. A cable sling 31B with a grip 32 and a hoist 34 are connected to the replacement static wire 20′″ to maintain the tension of the replacement static wire 20′″ through the pull zone 500. The puller 28B is then released to relieve the tension in the replacement static wire 20′″ between the puller 28B and the support structure 10E. In the option where the replacement static wire 20′″ is OPGW, enough OPGW is paid out from the puller 28A to be cut and allow the OPGW to be wrapped in a coil 58B at the base of the support structure 10E. For example, the other end of the OPGW may be secured close to or at the base of support structure 10E. In the option where the replacement static wire 20′″ is not OPGW, the static wire is cut at the top of the support structure 10E and the tail of the wire is lowered to the earth 100. The replacement static wire 20′″ is electrically connected to the structure grounding wire 22 of the support structure 10E by a ground wire 48. At this point, the replacement static wire 20′″ is grounded and secured to the take-off end of pull zone 500, for example at support structure 10E, while maintaining the tension across the replacement static wire 20′″ through the pull zone 500.

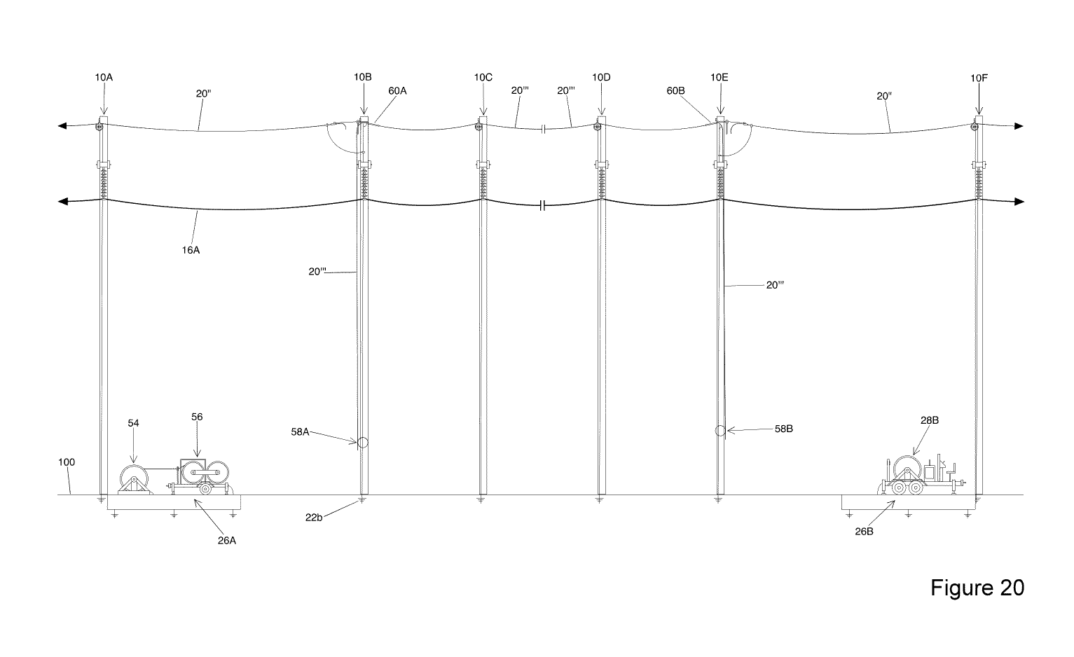

FIG. 20 depicts installation of a deadend 60B on the replacement static wire 20′″ at the take-up end of the pull zone 500, for example at the support structure 10E. Optionally, the tension of the replacement static wire 20′″ through the pull zone 500 may be adjusted at take-up end of the pull zone 500. For example, the chain hoist 52 at support structure 10E can be adjusted to provide more or less slack to the replacement static wire 20′″. The deadend 60A permanently supports the tension of the replacement static wire 20′″ and is electrically connected to the structure grounding wire 22. The traveller 24, the cable sling 31B, the grip 32, the hoist 34 and the ground wire 48 may now be removed from the take-up end of the pull zone 500. For example, these features may be removed from the support structure 10E.

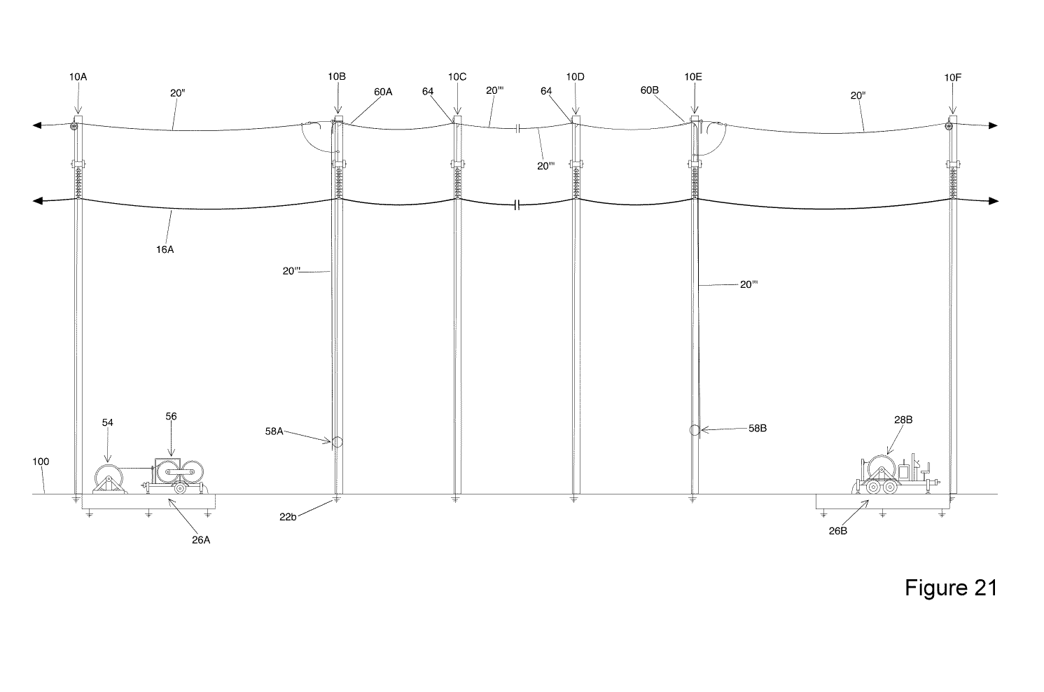

FIG. 21 depicts a connection between the replacement static wire 20′″ at each support structure 10 through the pull zone 500. For example, the replacement static wire 20′″ may be connected into a clamp 64 at, or near the top of the support structures 10B, C, D, E. The position of the replacement static wire 20′″ may or may not be the same as the position of the old static wire 20′. When connected in the clamp 64, the replacement static wire 20′″ may be directly connected to the structure grounding 22 of each support structure 10 within the pull zone 500. Any remaining travellers 24 that are supported on any support structure 10 within the pull zone 500 may now be removed.

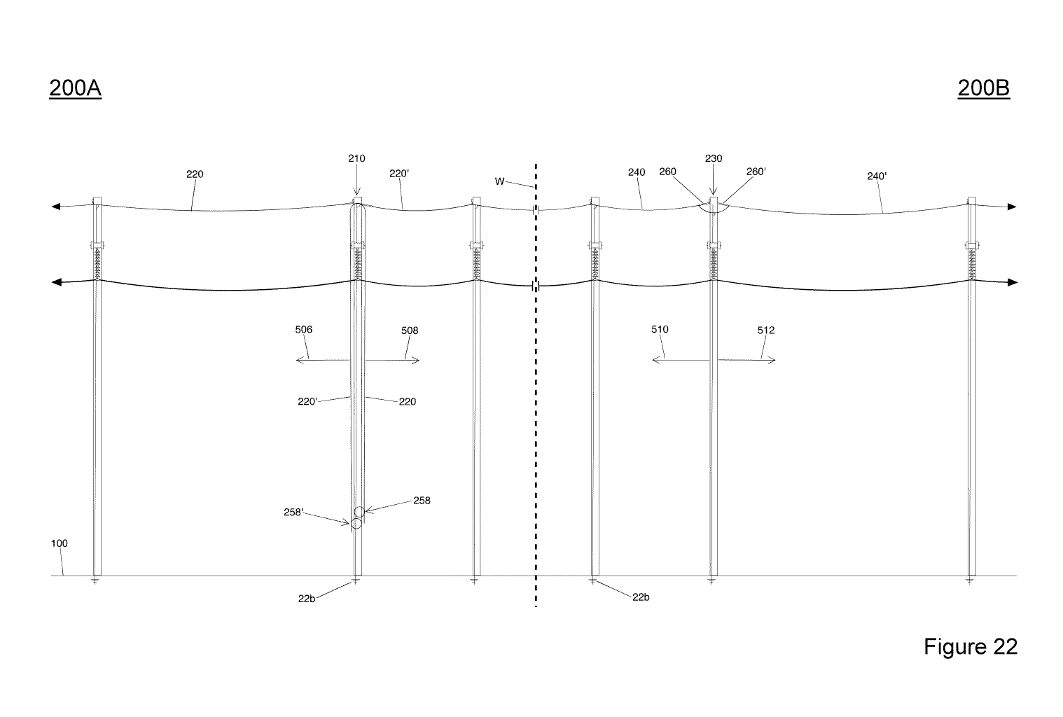

FIG. 22 depicts two examples of the system 200, with line w separating example system 200A from example system 200B. In system 200A, OPGW 220 is used as the replacement static wire 20′″. A support structure 210 is depicted as being at the end of a first pull zone 506 and the beginning of a second pull zone 508. The OPGW 220 from the first pull zone 506 is wrapped in a coil 258 near the bottom of the support structure 210 and the OPGW 220 is electrically connected to the structure grounding wire 22 of the support structure 210. The OPGW 220′ from the second pull zone 508 is also wrapped in a coil 258′ near the bottom of the support structure 210 and the OPGW 220′ is also electrically connected to the structure grounding wire 22 of the support structure 210.

In system 200B, a static wire 240 is used as the replacement static wire 20′″. A support structure 230 is depicted as being at the end of a first pull zone 510 and the beginning of a second pull zone 512. The static wire 240 of the first pull zone 510 is shown as ending at the support structure 230 with a deadend 260 and being electrically connected to the structure grounding wire 22 of the support structure 230. The static wire 240′ of the second pull zone 512 is shown as also ending at the support structure 230 with a deadend 260′ and being electrically connected to the structure grounding wire 22 of the support structure 230. Optionally, the two portions of static wire 240, 240′ may be connected to each other and the structure grounding wire 22.

As described in applicant's U.S. provisional patent application No. 61/968,543, entitled Flexible Isolation Device for Wire Stringing, filed Mar. 21, 2014, in the instance of a replacement static wire being pulled into an occupied static wire position, the existing static wire is utilized as a pulling line by positioning it in dollies or travelers, connecting it to the new static wire and pulling it utilizing for example a v-groove puller.

All pulling and tensioning equipment and conductor materials are situated upon equal potential zones (EPZ's) at each end of the pull. A running ground is placed upon the pulling line at the wire puller end and another running ground is placed on the new static wire at the tensioning end (payout). Close proximity stringing is executed in the same manner, with the exception that the circuit, static, or OPGW (collectively herein static wire) being replaced is de-energized, but is co-located with an energized circuit.

Although the static wire being installed is not directly energized, the close proximity of the energized phases imparts an induced voltage and current onto the pulling line and on the new static wire. The running grounds are used in order to protect the equipment and the workers who are required to be in close proximity to the wires. However, multiple ground potential points combined with the induced voltage and current create a ground circulating current with unknown and unpredictable electrical forces. A single point ground will greatly reduce this effect, but would leave one end of the pull unprotected.

Use of di-electric tested rope installed between the pulling line and the new static wire can be used to isolate the grounds, however the rope itself poses a safety hazard due to the potential for the rope to become contaminated by airborne particles, high humidity, or precipitation rendering the rope conductive thereby eliminating the isolation between the pulling line and the new static wire required.

The isolating insulator link or isolation link may be characterized in one aspect as including a flexible elongated tensionally-strong insulator such as a dielectric flexible member having terminating couplings mounted at either end. The couplings provide for relative torsion relief and relative bending moment relief between, respectively, the pulling line at one end of the isolation link and the new static wire at the other end of the isolation link. In one embodiment the couplings at either end of the elongated isolating insulator link each include a first joint allowing relative bi-directional movement between two portions, for example two halves, of the coupling. A second joint may be provided allowing relative rotation or swivelling about a longitudinal axis of the coupling.

The first joint may for example be a universal joint, or a ball joint, or a tensionally strong flexible stem encased within the coupling. The second joint may for example be a swivel. A single joint may be provided to replace the function of both the first and second joints.

As stated above, one example of the flexible member in isolation link 42 proposed by the applicant uses a length of dielectric rope which is encased in a flexible membrane, hose or tube (collectively herein a flexible tube), wherein the flexible tube is filled with dielectric oil so as to impregnate the dielectric rope and exclude air in the interstices between the fibres of the rope and in any voids between the rope and the walls of the tube. In one embodiment, each end of the isolation link, its length depending on the required insulation between the pulling wire 46 and the static wire 20′ as would be known to one skilled in the art, is sealed to maintain the oil in the tube and rope, and mounted in a terminating device to a joint or joints such as described above so as to resist a tensile force applied to the isolation link and allow relative motion between the end of the flexible member and the end of the pulling wire 46 or end of the static wire 20′ as the case may be.

Thus, as will now be understood, elimination of the circulating current while providing electrical protection on both ends of the pull may be accomplished by electrically isolating the pulling line or pulling wire from the new static wire using such an isolating link. This allows the installation of running grounds on both ends of the pull without creating a circulating current.

The flexible member is flexible or bendable or otherwise deformable (herein collectively referred to as flexible) to accommodate the bending radius of a traveler or dolly (as those terms are used interchangeably herein) and in one basic example is composed of a flexible high tensile strength, di-electric material with attachment joints or couplings on each end. The traveler or dolly at each support structure, such as at each tower, pole, etc., is conductive, and in particular is metallic and unlined, or has otherwise electrically conductive components and is grounded so that induced voltage and current in the section of the static wire being pulled through the dolly is also grounded via the dolly. The attachment joints or couplings of the isolating link, mounted at either end of the flexible member, are constructed in such a manner as to, in a preferred embodiment not intended to be limiting, control both rotation imparted by the cables and bi-directional shear induced when the connection or attachment points pass through the dollies. The isolating link, when properly maintained, is advantageously impervious to moisture, dirt, and airborne particles including dust, thereby mitigating the potential for the device, and in particular the flexible member becoming conductive during use. A re-inforced composite polymer or aramid, or combination of those or other synthetic rope fibres, for example in the form of a composite braided rope is one example of a flexible material which may be used in the flexible member. The flexible tube encasing the flexible member may for example be clear or transparent for ease of inspection for the presence of air in the tube or for the state of the rope, or may be partly clear (for example if the tube includes an inspection window strip along its length) or translucent. The tube may also for example be reinforced as for example found in conventional hydraulic hoses.

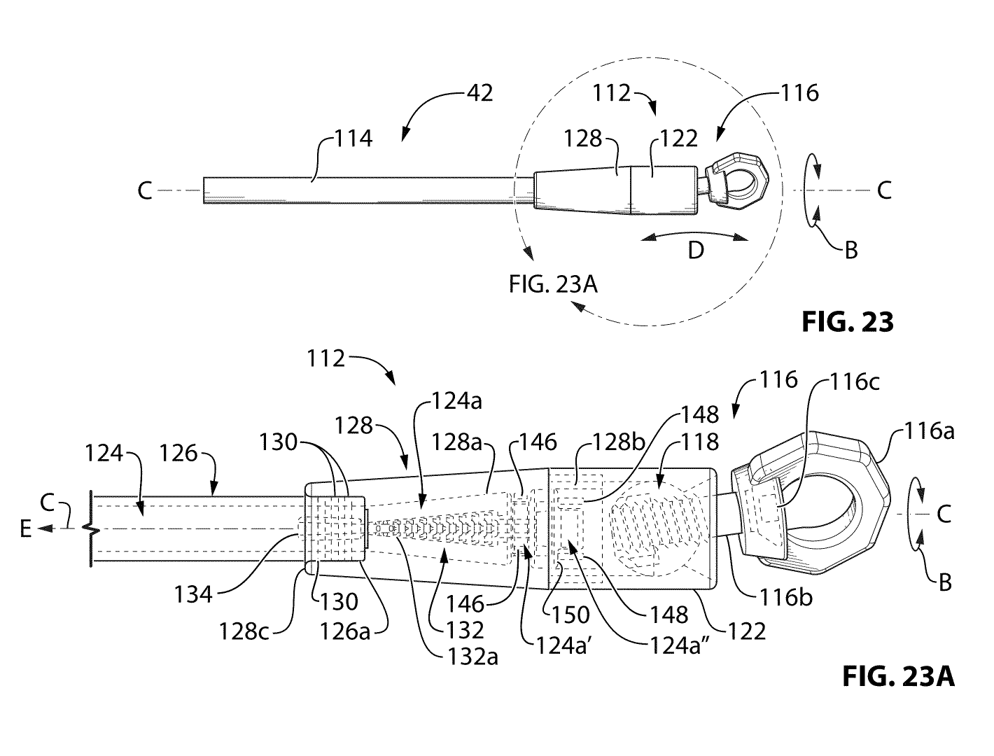

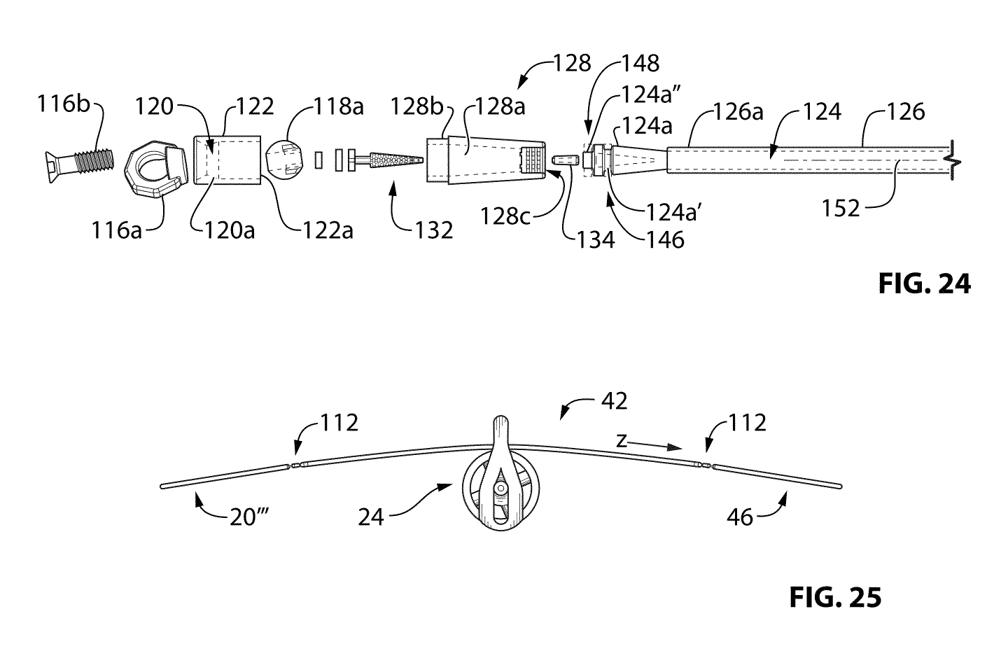

Thus as seen by way of example in FIGS. 23, 23A and 24, isolation link 42 includes attachment couplings 112 at either end of a length of a flexible member such as flexible di-electric insulator 114. The couplings themselves are not, at least need not be, constructed of di-electric material and may for example be made of stainless steel. The elongate dielectric flexible insulator 114 is of sufficient length to provide electrical isolation for the rated system voltage without the need for the connection joints or couplings 112 to be di-electric. In the instance, without intending to be limiting, of the isolation link 42 being used in a static wire replacement procedure according to the present disclosure, couplings 112 attach the flexible insulator 114 to the pulling wire 46 at a first coupling 112, and to the new static wire 20′″ at a second coupling 112, where the first and second couplings 112 are at opposite ends of isolation link 42. FIG. 15 illustrates pulling wire 42 in use pulling isolation link 42 and new static wire 20′″ through dollies or travelers 24 in direction Z.

In FIG. 23A one of the couplings 112 is seen enlarged. In FIG. 24 one of the couplings 112 is seen in partially exploded view. Although not intending to be limiting, in those embodiments, torsion resulting in relative rotation in direction B about longitudinal axis C between flexible insulator 114 and either the pulling wire 46 or the new static wire 20′″, is relieved by a swivel joint within bi-directional joint 116. Swivel couplings which may be employed are known to those skilled in the art but may for example include eye 116a rotatably mounted onto the end of shank 116b by means of swivel mount 116c. Bi-directional joint 116 is bi-directional in the sense that it allows for both rotation in direction B about axis C, but also rotation in direction D, the latter provided by ball joint 118 in joint 116 so as to accommodate the relative bi-directional movement caused by shear and bending as the coupling 112 passes through and over a dolly 24. In the illustrated example, ball 118a is threadably mounted onto shank 116b. Ball 118a is mounted for rotation within ball socket 120 formed within socket housing 122. In particular, ball 118a rests against shoulder 120a in socket 120. Bi-directional joint 112b may be of various designs as would be known to one skilled in the art. For example, and without intending to be limiting, bi-directional joint 112b may be a form of universal joint, or such as the illustrated ball-joint, or may include an encased narrow, flexible stem (not shown) having sufficient tensile strength and which coupling joins one part of coupling 112 to the other part of coupling 112.

As described above, flexible member 114 in a preferred embodiment includes a synthetic rope encased in a tube and mounted at each end thereof to a corresponding coupling 112. Thus as seen in FIGS. 23A and 24, rope 124 is snugly shrouded in flexible tubing 126. Tubing 126 is shorter than the length of the end of the rope 124 so as to expose the end 124a from the end of the tube. Spelter socket 128 is hollow along axis C and provides a frusto-conical wedging cavity 128a between the threaded male end 128b and the oppositely dispose female end 128c. Male end 128b threadably engages with the threaded female end 122a of socket housing 122. Female end 128c engages with the end 126a of tube 126. As in this embodiment, which is not intended to be limiting, a tension load on flexible member 114 in direction E is to be taken up by rope 124, and not to an appreciable degree by tube, acting on spelter socket 128, tubing 126 may be mounted into spelter socket 128, and specifically into female end 128c, in a snug friction fit sealed by seals 130. Seals 130 may for example be O-rings or such other seals as would be known to one skilled in the art, to create and maintain a fluidic seal between end 126a of tubing 126 and the interior annular surface of female end 128c.

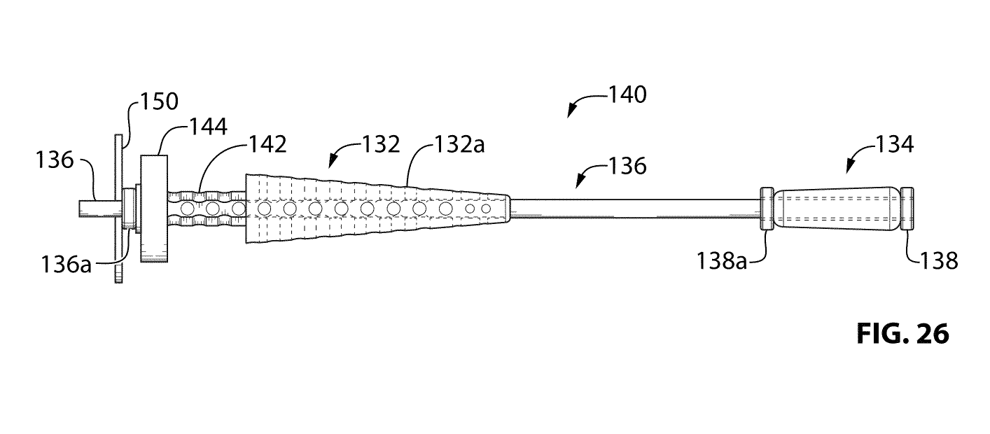

The end 124a of rope 124 is flared radially outwardly relative to axis C as a result of, and so as to accommodate, the insertion of a conical first or primary spelter plug 132 best seen in FIG. 26 along the core of the rope 124. The primary spelter plug 132 is provided to assist in anchoring the end 124a of rope 124 into the spelter socket 128. The spelter plugs are also referred to herein as spelters. In the illustrated embodiment, which is not intended to be limiting, a second or secondary spelter plug 134, which may have a small reverse taper relative to the taper on the primary spelter plug, is also provided to also assist in anchoring the end 124a of rope 124 into the spelter socket 128 and to assist in maintaining the seating of the seals 130 when the rope is under tensile loading. Spelter plug 134 may be rigidly mounted to spelter plug 132 by for example a rod 136, seen in FIG. 26. The ends of rod 136 may be threaded, and the spelter plugs 132, 134 hollow so as to accommodate rod 136 journalled through the lengths of the spelter plugs and the plugs anchored onto the rod by nuts 138. A positioning nut 138a may be used to hold spelter plug 134 in a desired position along rod 136.

Primary spelter plug 132 has a tapered or conically wedge-shaped surface 132a which is sized and wherein the taper is inclined relative to axis C at such an angle, for example at the same angle relative to axis C as the surface of frusto-conical cavity 128b in spelter socket 128, so as to evenly sandwich, i.e., to substantially evenly distribute a pressure loading to, end 124a of rope 124 between the surface of cavity 128a and the surface 132a of primary spelter plug 132 when tension is applied to rope 124 in direction E in the arrangement best seen in FIG. 23A. Secondary spelter plug is advantageously positioned along rod 136 so that once spelter lock 140 (in this embodiment spelters 132, 134 and rod 136) is pushed into and along the centroidal core of the end 124a of rope 124, and the spelter lock 140 and the end of rope 124 slid into the spelter socket 128, not only is the end 124a of the rope 124 flared over the primary spelter 132, but the portion of the rope covering the secondary spelter 134 is radially outwardly compressed. Thus, just as the primary spelter compresses the end of the rope 124 against the frusto-conical cavity 128a, the secondary spelter compresses against the interior surface of female end 128c the portion of the rope 124 and tube 126 sandwiched between the secondary spelter 134 and the interior surface of female end 128c of spelter socket 128. This radially outward compression of the rope and tube in the female end of the spelter socket may assist in holding the fluidic sealing of seals 130 when rope 124 in under tension in direction E and when thus the rope may be of reduced diameter. Such a radially outward compression also may increase the frictional engagement of the secondary spelter in the rope 124 to assist in holding the rope in the spelter socket 128.

The spelter lock 140 also includes a neck 142 and an annular locking flange 144. Neck 142 is of reduced radial diameter relative to the radial diameters of the widest end of primary spelter 132 and relative to the diameter of locking flange 144. The length of neck 142 is such that a first di-electric clamp 146 (shown in dotted outline in FIG. 24), such as a di-electric hose clamp one example of which being a plastic strap, may be used to pinch or compress a corresponding annular portion 124a′ of end 124a of rope 124 into the annular channel formed around neck 142 between primary spelter 132 and locking flange 144. This locks the end of the rope onto the spelter lock 140. A second di-electric clamp 148 (also shown in dotted outline) may be used to further lock a second rope portion 124a″ of the rope end 124a onto the spelter lock by clamping the rope portion 124a″ down onto the end of the rod 136 on the opposite side of locking flange 144 from neck 142.

Because rod 136 may be metallic, as may be the primary and/or secondary spelters 132,134, and indeed all of spelter lock 140, an electrically conductive connection should be provided, such as a spider or star washer 150 seen in FIG. 26, between rod 136 and the interior surface of spelter socket 128 adjacent surface 128a. One or more set screws (not shown) may advantageously be provided, acting for example between housing 122 and the male end 128b of spelter socket 128, to resist inadvertent unscrewing of the housing 122 from the spelter socket 128.

A dielectric fluid, for example a dielectric fluid such as oil (e.g., viscosity of about 0.5 centi-Stoke) or a viscous fluid or gel such as fluidic silicone, or other dielectric fluids as would be known to one skilled in the art, is impregnated into rope 124 and filled into the interstices between rope 124 and tube 126 so as not to leave any air bubbles or air pockets. The dielectric fluid fills the tube and completely impregnates between the fibres of the rope along the entire length of the rope and tube extending between and into the couplings 112. To stop the dielectric fluid from escaping from within cavity 128a and past the clamps 146, 148, which themselves will act as seals inhibiting the movement of the dielectric fluid along the rope fibres so as to leak into the cavity of housing 122, a further seal (not shown) may be provided. One example of such a further seal, and without intending to be limiting, is to fill the cavity in the spelter socket with epoxy resin while in its fluid state, and let the epoxy harden while completely filling any voids in the spelter socket cavity.

In one embodiment, hollow flexible spinal member 152 seen in dotted outline in FIG. 24, which may be a narrow diameter flexible tube, is inserted along the length of the core of rope 124. The function of the spinal member 152 is to recirculate the dielectric fluid from one end of the flexible member 114 to the other end of flexible member 114 when the dielectric fluid becomes pressurized at one end as the link 42 passes over a dolly 24.

While the above disclosure describes certain examples of the present invention, various modifications to the described examples will also be apparent to those skilled in the art. The scope of the claims should not be limited by the examples provided above; rather, the scope of the claims should be given the broadest interpretation that is consistent with the disclosure as a whole.

What is claimed is:

1. A method of stringing a replacement static wire so as to replace a length of an existing static wire needing replacement within a pull zone having a plurality of support structures supporting the existing static wire and an overhead energized power line along and above a corresponding segment of the energized overhead power line, wherein the length of existing static wire has opposite first and second ends, the method comprising:
a. providing a pulling wire, and an electrically insulated isolation link, and connecting a first end of the pulling wire to the first end of the length of existing static wire using the isolation link;
b. pulling the length of existing static wire from the pull zone by pulling the second end of the length of existing static wire until the isolation link is at the corresponding end of, or out of, the pull zone, and then disconnecting the length of existing static wire from the isolation link;
c. providing a length of replacement static wire corresponding in length to the now removed length of existing static wire and joining a first end of the length of replacement static wire to the isolation link;
d. pulling on the second end of the pulling wire, opposite the first end of the pulling wire, to thereby replace into the pull zone the length of replacement static wire for the length of existing static wire;
e. maintaining an electrically grounded connection at least between earth and the length of existing static wire at least during steps (a) and (b);
f. maintaining an electrically grounded connection at least between the earth and the replacement static wire at least during steps (c) and (d);
g. maintaining an electrically grounded connection at least between earth and the length of pulling wire at least during steps (a), (b), (c) and (d);
h. maintaining the electrically grounded connection in step (e) at substantially each of the support structures supporting the length of existing static wires as the pulling of the length of existing static wires from the pull zone proceeds; and
i. maintaining the electrically grounded connection in step (f) at substantially each of the support structures supporting the length of the replacement static wire as the replacing of the length of replacement static wire into the pull zone proceeds.

2. The method of claim 1, further comprising steps of establishing a first equal-potential zone at a first end of the pull zone and establishing a second equal-potential zone at a second end of the pull zone.

3. The method of claim 2, wherein the step (b) of pulling the length of existing static wire further comprises a step of reeling the existing static wire into the first equal-potential zone.

4. The method of claim 3, further comprising a step of maintaining a grounded electrical connection between the existing static wire and the first equal-potential zone while reeling in the existing static wire, and maintaining an electrically grounded connection at least between the second equal-potential zone and the length of pulling wire.

5. The method of claim 2, wherein the step (d) of replacing the length of replacement static wire further comprises a step of paying out the replacement static wire from the first equal-potential zone.

6. The method of claim 5, further comprising a step of maintaining a grounded electrical connection between the replacement static wire and the first equal-potential zone while paying out the replacement static wire, and maintaining an electrically grounded connection at least between the second equal-potential zone and the length of pulling wire.

7. The method of claim 5, further comprising a step of maintaining a tension across the replacement static wire during the step of paying out the replacement static wire.

8. The method of claim 1, wherein the step (b) of pulling the length of existing static wire further comprises steps of connecting a further wire to the second end of the length of static wire and pulling the further wire.

9. The method of claim 8, wherein the step (c) of connecting the first end of the length of the replacement static wire to the pulling wire further comprises a step of disconnecting the length of existing static wire from both the isolation link and the further wire.

10. The method of claim 1, wherein the step (h) comprises a step of electrically connecting the first end of the existing static wire to a grounding wire of a first support structure of the plurality of support structures at one end of the pull zone and electrically connecting the second end of the existing static wire to a grounding wire of a second support structure of the plurality of support structures at another end of the pull zone before step (a).

11. The method of claim 10, further comprising a step of electrically connecting a portion of the length of replacement static wire that is proximal to the first end thereof to the grounding wire of the second support structure and electrically connecting a portion of the length of replacement static wire that is proximal to the second end thereof to the grounding wire of the first support structure after step (d).

12. The method of claim 1, wherein the replacement static wire is optical grounding wire (OPGW).

13. The method of claim 12, further comprising steps of securing the first end of the length of replacement static wire proximal to a base of the second supporting structure and securing the second end of the length of replacement static wire proximal to a base of the first supporting structure.

14. The method of claim 1, wherein the step (h) of maintaining the electrically grounded connection between the existing static wire and the replacement static wire to substantially each support structure of the system comprises a step of supporting the existing static wire and the replacement static wire at each of the support structures within the pull zone upon a grounded electrically conductive traveller.

15. A method of stringing static wires within a pull zone of an electrified overhead power line system, the method comprising:
a. providing an isolation link between a pulling wire and a first end of a length of an old static wire;
b. pulling the length of the old static wire from the pull zone by a second end of the length of the old static wire;
c. joining a first end of a length of replacement static wire to the pulling wire proximal to the isolation link;
d. stringing in the length of replacement static wire into the pull zone by pulling on the pulling wire;
e. maintaining an electrically grounded connection between earth and both the old static wire at least during steps (a) and (b), and the pulling wire;
f. maintaining an electrically grounded connection between the earth and both the replacement static wire at least during steps (c) and (d); and the pulling wire; and
g. maintaining an electrically grounded connection between the old static wire and the replacement static wire to substantially each support structure of the system, and therealong to the earth, along the pull zone.

16. The method of claim 15, further comprising steps of establishing a first equal-potential zone at a first end of the pull zone and establishing a second equal-potential zone at a second end of the pull zone.

17. The method of claim 16, wherein the step (b) of pulling the length of old static wire further comprises a step of reeling the old static wire into the first equal-potential zone.

18. The method of claim 17, further comprising a step of maintaining a grounded electrical connection between both the old static wire and the pulling wire and the first equal-potential zone while reeling in the old static wire.

19. The method of claim 16, wherein the step (d) of stringing the length of replacement static wire further comprises a step of paying out the replacement static wire from the first equal-potential zone.

20. The method of claim 19, further comprising a step of maintaining a grounded electrical connection between both the replacement static wire and the pulling wire and the first equal-potential zone while paying out the replacement static wire.

21. The method of claim 19, further comprising a step of maintaining a tension across the replacement static wire during the step of paying out the replacement static wire.

22. The method of claim 15, wherein the step (b) of pulling the length of old static wire further comprises steps of connecting a wire to the second end of the length of static wire and pulling the wire.

23. The method of claim 22, wherein the step (c) of joining the first end of the length of the replacement static wire to the pulling wire further comprises a step of disconnecting the length of old static wire from the isolation link and the wire.

24. The method of claim 15, wherein the step (g) of maintaining the electrically grounded connection between the old static wire and the replacement static wire to substantially each support structure of the system comprises a step of electrically connecting the first end of the old static wire to a grounding wire of a first support structure at one end of the pull zone and electrically connecting the second end of the old static wire to a grounding wire of a second support structure at the other end of the pull zone before step (a).

25. The method of claim 24, further comprising a step of electrically connecting a portion of the length of replacement static wire that is proximal to the first end thereof to the grounding wire of the second support structure and electrically connecting a portion of the length of replacement static wire that is proximal to the second end thereof to the grounding wire of the first support structure after step (d).

26. The method of claim 15, wherein the replacement static wire is optical ground wire.

27. The method of claim 26, further comprising steps of securing the first end of the length of replacement static wire proximal to a base of the second supporting structure and securing the second end of the length of replacement static wire proximal to a base of the first supporting structure.

28. The method of claim 15, wherein the step (g) of maintaining the electrically grounded connection between the old static wire and the replacement static wire to substantially each support structure of the system comprises a step of supporting the old static wire and the replacement static wire at each support structure within the pull zone upon an electrically conductive traveller.

29. A system for replacing at least one old static wire that is supported between two or more support structures that also support at least one electrified conductor below the at least one old static wire, wherein the at least one old static wire is electrically connected to earth through a grounding wire at each support structure, the system comprising:
a. a first puller connectible to a first end of the at least one old static wire and is adapted for pulling the at least one old static wire in a first direction, and a static wire supporting and running grounding device at each support structure to maintain an electrical connection between the at least one old static wire and the earth at each support structure during the pulling in the first direction;
b. a second puller that is connectible to a second end of the at least one old static wire and is adapted for pulling the at least one old static wire in a second direction through the static wire supporting and running ground device at each support structure to maintain an electrical connection between the at least one static wire and the earth during the pulling in the second direction;
c. a removable joint to connect the second puller to the second end of the at least one old static wire, the joint including an electrically insulated connection;
d. a length of replacement static wire that is connectible to the joint;
e. a first equal potential zone that is adapted for electrically connecting the first puller to the earth; and
f. a second equal potential zone that is adapted for electrically connecting the second puller to the earth.

30. The system of claim 29, wherein the electrically insulated connection is an isolation link.

31. The system of claim 29, wherein each static wire supporting and running ground device is an electrically conductive traveller that is positionable upon the two or more support structures to support the at least one old static wire and provide a running ground therefore at each of the support structures.

32. The system of claim 31, wherein each of the electrically conductive travellers is adapted to support the length of replacement static wire.

33. A system for replacing at least one old static wire that is supported between two or more support structures that also support at least one electrified conductor, the at least one old static wire is electrically connected to earth through a grounding wire at each support structure, the system comprising:
a. a first puller connectible to a first end of the at least one old static wire and is adapted for pulling the at least one old static wire in a first direction while maintaining an electrical connection between the at least one old static wire and the earth;
b. a second puller that is connectible to a second end of the at least one old static wire and is adapted for pulling the at least one old static wire in a second direction while maintaining an electrical connection between the at least one static wire and the earth;
c. a joint for removably connecting the second puller to the second end of the at least one old static wire, the joint comprising a grip and an electrically insulated connection;
d. a length of replacement static wire that is connectible to the joint; and
e. a plurality of electrically conductive travellers that are adapted for rotatably supporting the at least one old static wire upon the two or more support structures and for maintaining the electrical connection between the at least one old static wire and the earth through the grounding wire at each support structure.

34. The system of claim 33, wherein the electrically insulated connection is an isolation link.
